(19) United States
(12) Patent Application Publication
(10) Pub. No.: US 2020/0293955 A1
(43) Pub. Date: Sep. 17, 2020

(54) FOOD ORDERING SYSTEM, PLATFORM, AND METHOD OF USE

(71) Applicant: Ehteshamuddin Ghori Mohammed, Farmington Hills, MI (US)

(72) Inventor: Ehteshamuddin Ghori Mohammed, Farmington Hills, MI (US)

(21) Appl. No.: 16/725,335

(22) Filed: Dec. 23, 2019

Related U.S. Application Data
(60) Provisional application No. 62/816,619, filed on Mar. 11, 2019.

(51) Int. Cl. G06Q 10/02; G06Q 30/06; G06Q 50/12; G06F 16/9535; H04L 29/08

(52) U.S. Cl. CPC G06Q 10/02; G06Q 30/0645; G06Q 50/12; G06F 3/0482; G06F 16/9535; H04L 67/306; G06Q 30/0633

(57) ABSTRACT

A system, platform, and method are disclosed herein for customizing pages of a chef and kitchen reservation booking website with deep-links for specialized rental kitchen reservations. The specialized rental kitchen reservations may comprise any qualified chef or self-taught cooks who have registered in the system. The specialized kitchen rental may be defined for the website through an administrative tool. The specialized kitchen rental platform and system may be utilized by one or more users to book a specialized kitchen for single food items and/or entire events.

### CROSS-REFERENCE TO RELATED APPLICATIONS

The present application claims priority to U.S. Provisional Patent Application No. 62/816,619 which was filed on Mar. 11, 2019, which, is hereby incorporated by reference herein in its entirety, including any figures, tables, or drawings.

### FIELD OF THE DISCLOSURE

The present disclosure relates generally to an online platform. More specifically, the present disclosure is an online food ordering system, platform, and method of use which allows customers to order food from any qualified chefs or self-taught cooks who have registered in the system. The present disclosure is specifically designed for ordering food. However, the present disclosure is not limited to this option, and it may further be adapted for a variety of purposes.

### COPYRIGHT NOTICE

At least a portion of the disclosure of this patent document contains material that is subject to copyright protection. The copyright owner has no objection to the facsimile reproduction by anyone of the patent document or the patent disclosure, as it appears in the Patent and Trademark Office patent files and/or records, but otherwise reserves all copyright rights whatsoever. The following notice applies to the software and data as described below and in the drawings that form a part of this document: Copyright Foodjin, Inc. All rights reserved.

### BACKGROUND OF THE DISCLOSURE

Advances in information technology and the Internet have driven huge shifts in consumer behavior and business models. Many traditional restaurants and food vendors have developed websites and/or mobile applications to attract more customers. The customers can view the menu on the website/app and submit food orders online. Once the food is prepared, the food is delivered by the restaurant or third-party delivery service to a delivery location specified by the customer. Compared with telephone ordering, online food ordering has the following advantages: it eliminates the language barrier between customers and the restaurants or food vendors; the menu can be updated in a convenient and cost-effective manner; human error in entering delivery addresses or menu items may be greatly reduced.

However, existing online food ordering method only allows the customers to order food from restaurants and food vendors. Customers have no idea who is preparing the food for them. Meanwhile, people who have great culinary expertise but do not have enough funds or time to run a traditional restaurant are unable to sell their food online, and thus customers do not get the chance to try different homemade cuisine. The present invention aims to solve some of these problems by disclosing a food ordering platform which connects customers with a selection of cooks such that food can be directly ordered from the cooks and delivered to customers' door.

### SUMMARY OF THE DISCLOSURE

The present disclosure is a food ordering platform which can operate on a mobile device or other electronic devices to help customers order different kinds of food from a variety of cooks, such that the customers have the opportunity to experience unique customized food. The present disclosure also provides a platform which allows cooks, who do not have enough funds to launch their own restaurant, so as to create their own virtual catalog so as to offer food to customers.

Thus, it is a primary object of the disclosure to provide a food ordering system, platform, and method of use that improves upon the state of the art.

Another object of the disclosure is to provide a food ordering system, platform, and method of use that is easy to use.

Yet another object of the disclosure is to provide a food ordering system, platform, and method of use that is high quality.

Another object of the disclosure is to provide a food ordering system, platform, and method of use that is durable.

Yet another object of the disclosure is to provide a food ordering system, platform, and method of use that is robust.

Another object of the disclosure is to provide a food ordering system, platform, and method of use that is secure.

Yet another object of the disclosure is to provide a food ordering system, platform, and method of use that has an easy account creation and login.

Another object of the disclosure is to provide a food ordering system, platform, and method of use that requires credentials such as licenses.

Yet another object of the disclosure is to provide a food ordering system, platform, and method of use that has a background check.

Another object of the disclosure is to provide a food ordering system, platform, and method of use that has a daily order list.

Yet another object of the disclosure is to provide a food ordering system, platform, and method of use that has a news feed.

Another object of the disclosure is to provide a food ordering system, platform, and method of use that can be used from a mobile device.

Yet another object of the disclosure is to provide a food ordering system, platform, and method of use that can include pictures and/or videos.

Another object of the disclosure is to provide a food ordering system, platform, and method of use that has a plurality of order identifiers and trackers.

Yet another object of the disclosure is to provide a food ordering system, platform, and method of use that provides an easy to use catalogue.

Another object of the disclosure is to provide a food ordering system, platform, and method of use that allows a chef to register under certain food criteria.

Yet another object of the disclosure is to provide a food ordering system, platform, and method of use that has a unique review and rating system.

Another object of the disclosure is to provide a food ordering system, platform, and method of use that

Yet another object of the disclosure is to provide a food ordering system, platform, and method of use that provides business license upload.

Another object of the disclosure is to provide a food ordering system, platform, and method of use that provides employer identification upload.

Yet another object of the disclosure is to provide a food ordering system, platform, and method of use that provides food service license sharing.

Another object of the disclosure is to provide a food ordering system, platform, and method of use that provides business insurance sharing.

Yet another object of the disclosure is to provide a food ordering system, platform, and method of use that provides food handlers license sharing.

Another object of the disclosure is to provide a food ordering system, platform, and method of use that provides easy payment method editing.

Yet another object of the disclosure is to provide a food ordering system, platform, and method of use that provides easy payout method changes.

Another object of the disclosure is to provide a food ordering system, platform, and method of use that provides for business and/or unique kitchen creation.

Yet another object of the disclosure is to provide a food ordering system, platform, and method of use that provides for permit sharing.

Another object of the disclosure is to provide a food ordering system, platform, and method of use that provides occupancy sharing.

Yet another object of the disclosure is to provide a food ordering system, platform, and method of use that provides customized business listings.

Another object of the disclosure is to provide a food ordering system, platform, and method of use that provides for kitchen booking, Yet another object of the disclosure is to provide a food ordering system, platform, and method of use that provides for availability checking.

Another object of the disclosure is to provide a food ordering system, platform, and method of use that provides kitchen renting.

Yet another object of the disclosure is to provide a food ordering system, platform, and method of use that provides easy online payment.

Another object of the disclosure is to provide a food ordering system, platform, and method of use that provides database for future bookings.

Yet another object of the disclosure is to provide a food ordering system, platform, and method of use that provides a food item management system.

Another object of the disclosure is to provide a food ordering system, platform, and method of use that provides for menu and course publishing options.

Yet another object of the disclosure is to provide a food ordering system, platform, and method of use that provides flexible item editing, publishing, and removal.

Another object of the disclosure is to provide a food ordering system, platform, and method of use that provides attributes for items.

Yet another object of the disclosure is to provide a food ordering system, platform, and method of use that provides nutrition facts for items.

Another object of the disclosure is to provide a food ordering system, platform, and method of use that provides an order management system.

Yet another object of the disclosure is to provide a food ordering system, platform, and method of use that provides an easy to use and understand orders list Another object of the disclosure is to provide a food ordering system, platform, and method of use that provides an order tracking system.

Yet another object of the disclosure is to provide a food ordering system, platform, and method of use that provides an order status system.

Another object of the disclosure is to provide a food ordering system, platform, and method of use that provides new order notifications.

Yet another object of the disclosure is to provide a food ordering system, platform, and method of use that provides push notifications.

Another object of the disclosure is to provide a food ordering system, platform, and method of use that provides an accounting system.

Yet another object of the disclosure is to provide a food ordering system, platform, and method of use that provides an earnings history.

Another object of the disclosure is to provide a food ordering system, platform, and method of use that provides earnings in progress information.

Yet another object of the disclosure is to provide a food ordering system, platform, and method of use that provides information about earnings in review.

Another object of the disclosure is to provide a food ordering system, platform, and method of use that allows chefs to post to a news feeds.

Yet another object of the disclosure is to provide a food ordering system, platform, and method of use that provides various feeds for chefs and/or users to view and post

Another object of the disclosure is to provide a food ordering system, platform, and method of use that provides a system to connect chefs and users so that users can get access to chef services.

Yet another object of the disclosure is to provide a food ordering system, platform, and method of use that provides a platform for users to order a plurality of dishes and/or chef services.

Another object of the disclosure is to provide a food ordering system, platform, and method of use that provides an online platform for rating, and reviewing chefs and/or their services they provide, Yet another object of the disclosure is to provide a food ordering system, platform, and method of use that provides a method of using a system for ordering food or booking food services.

These and other objects, features, or advantages of the present disclosure will become apparent from the specification and claims.

### BRIEF DESCRIPTION OF THE DRAWINGS

FIG. 1 is a diagram illustrating a user interface of a splash screen;

FIG. 2 is a diagram illustrating a user interface for customer registration;

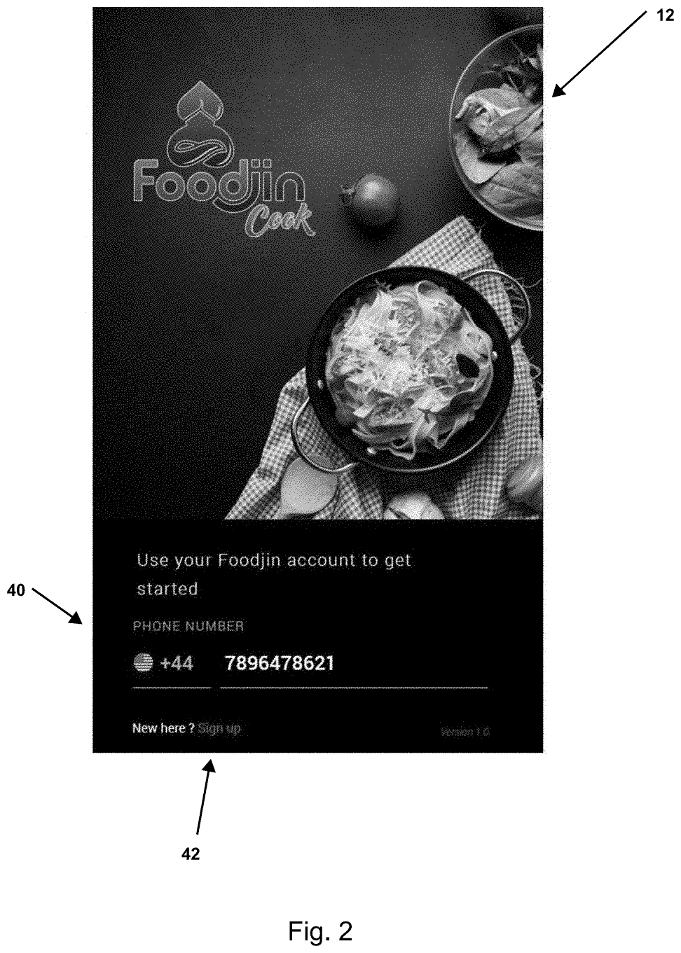

FIG. 3 is a diagram illustrating a user interface for customer registration;

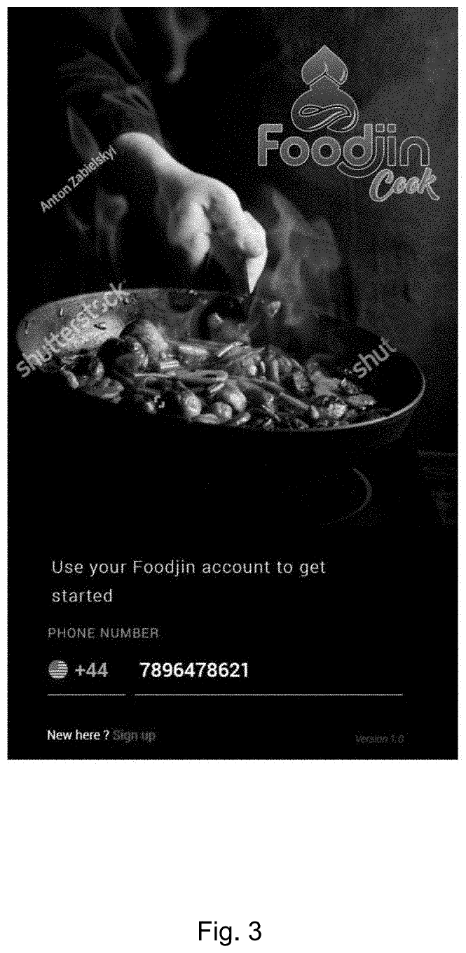

FIG. 4 is a diagram illustrating a user interface for customer registration;

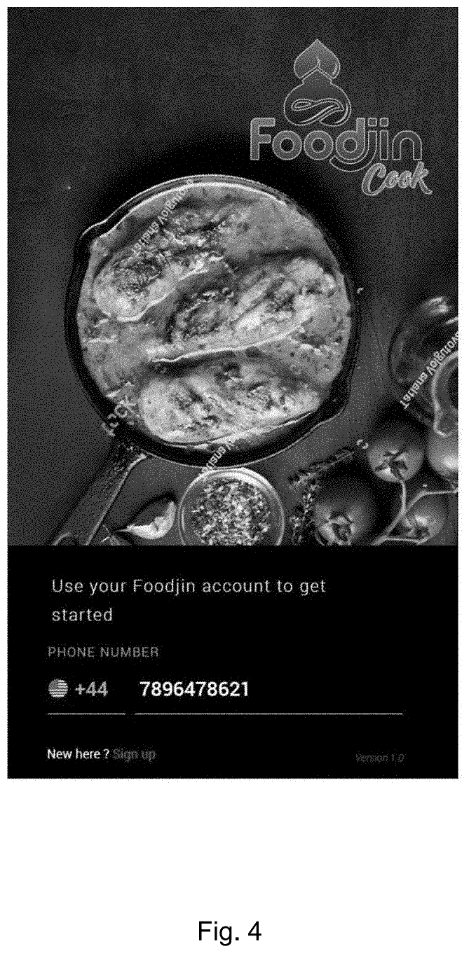

FIG. 5 is a diagram illustrating a user interface for customer registration;

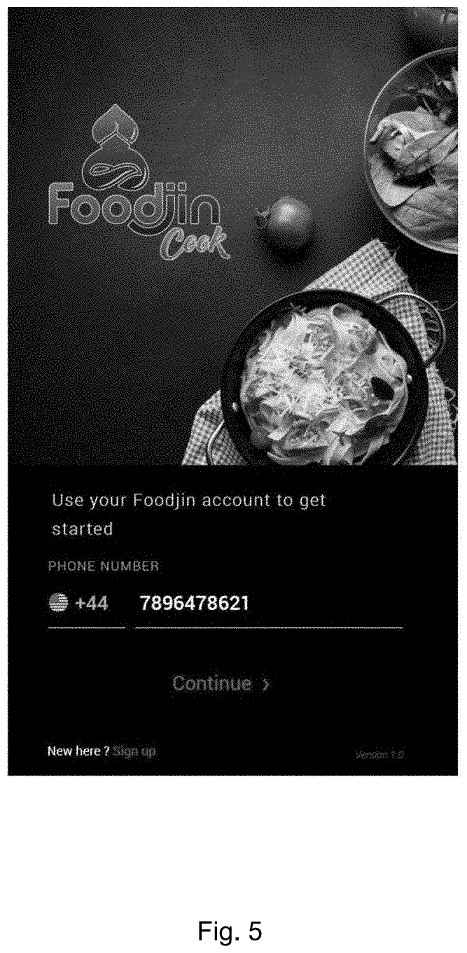

FIG. 6 is a diagram illustrating a user interface for customer registration; the view showing a password page;

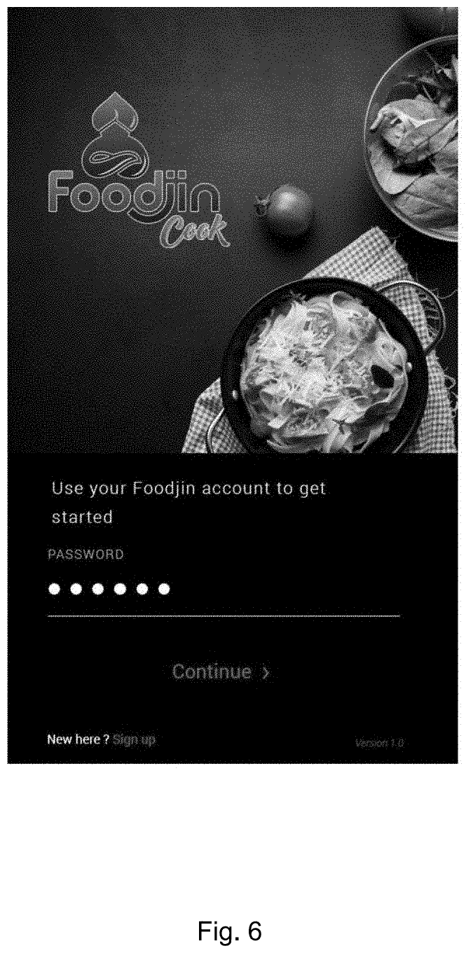

FIG. 7 is a diagram illustrating a user interface for customer registration; the view showing the create account details page;

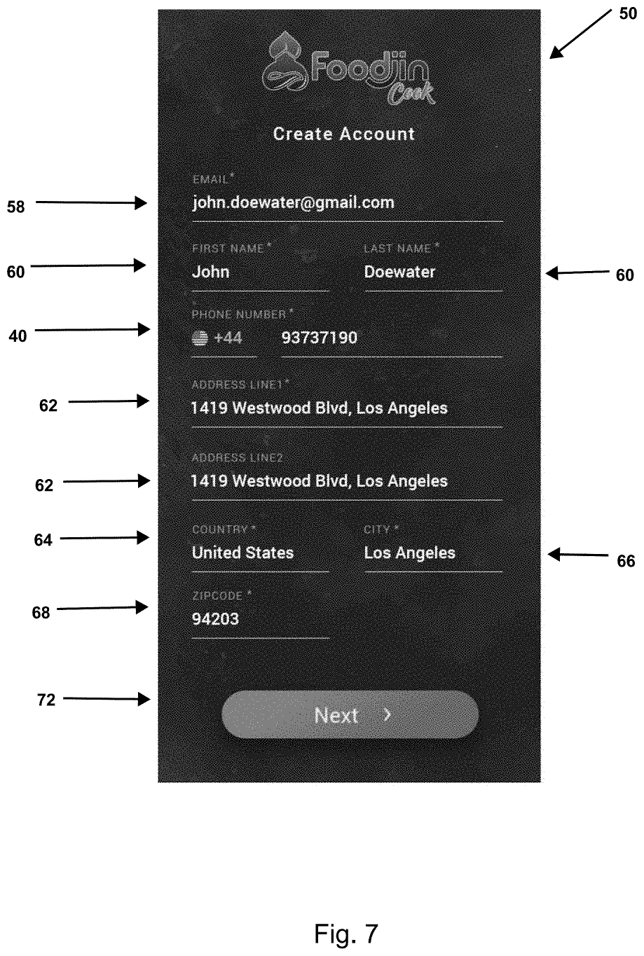

FIG. 8 is a diagram illustrating a user interface for customer registration; the view showing a background check;

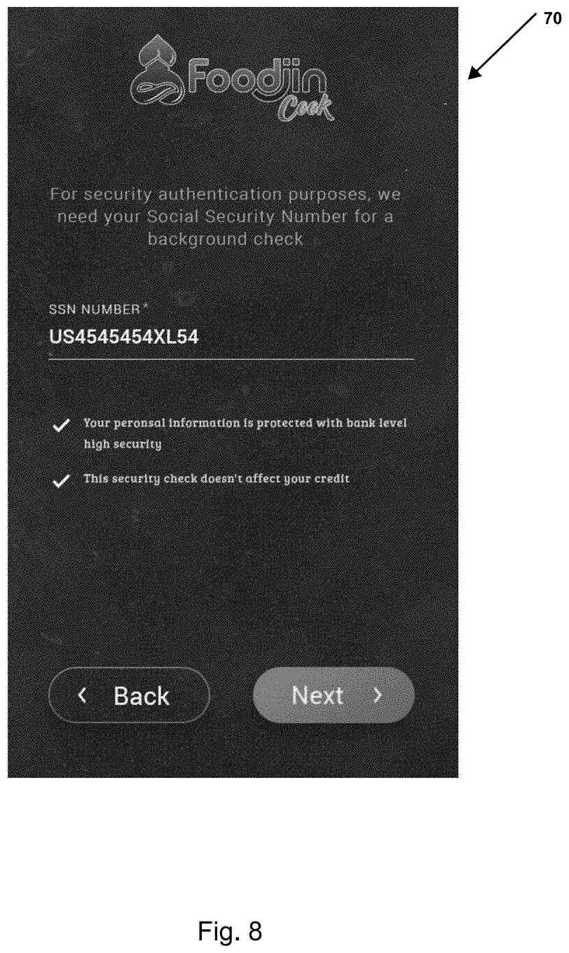

FIG. 9 is a diagram illustrating a user interface for customer registration; the view showing, security registration verification requirement;

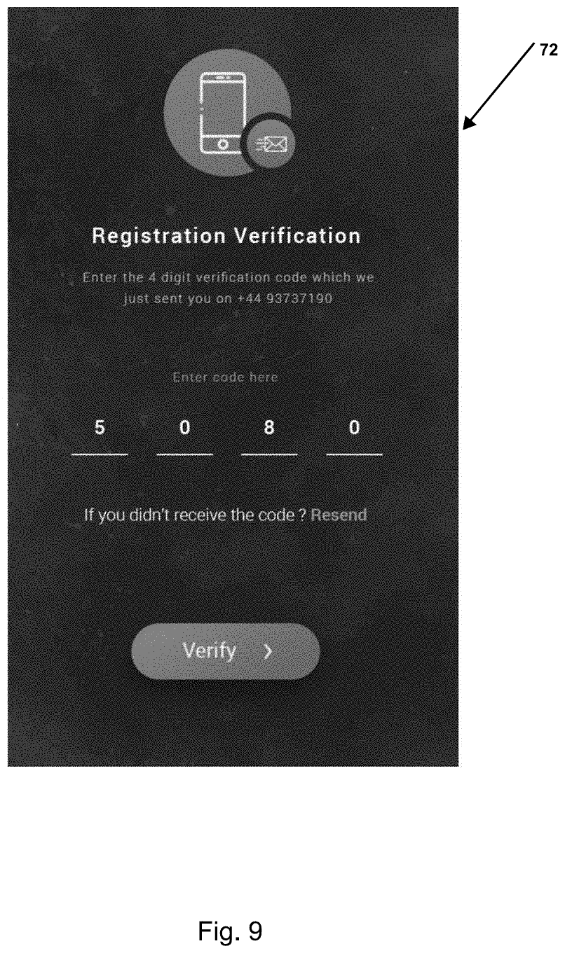

FIG. 10 is a diagram illustrating a user interface for a home page;

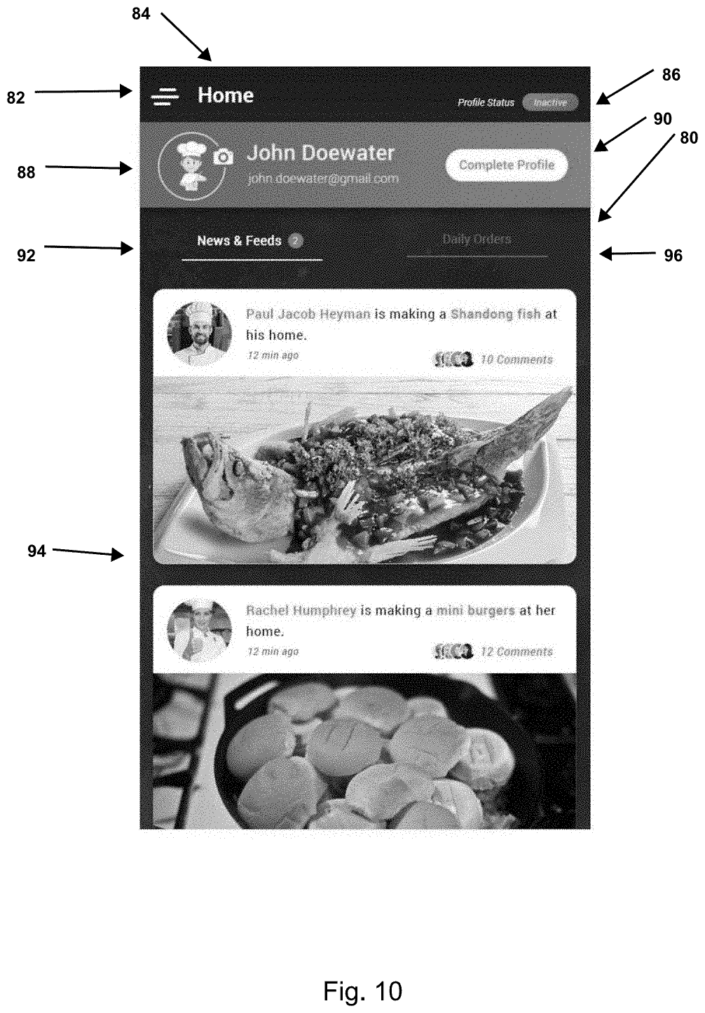

FIG. 11 is a diagram illustrating a user interface for a home page; the view showing a daily orders tab; the view showing no orders;

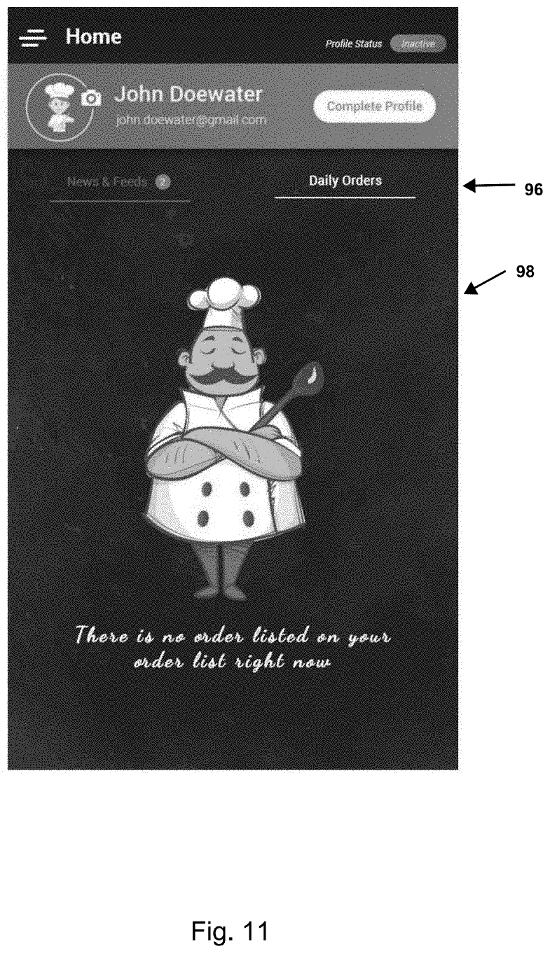

FIG. 12 is a diagram illustrating a user interface for a home page; the view showing a news & feed tab;

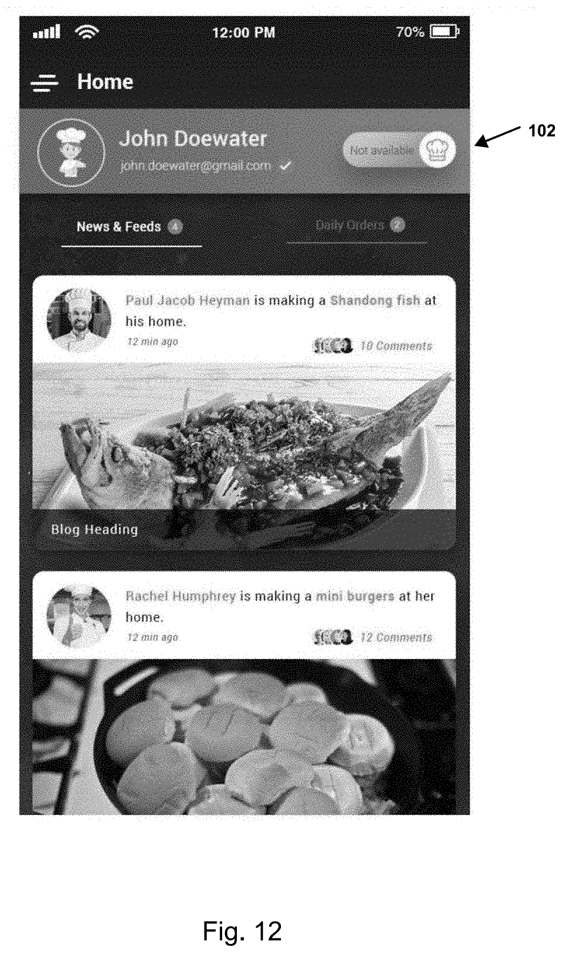

FIG. 13 is a diagram illustrating a user interface for a home page; the view showing a daily orders tab; the view showing a plurality of orders;

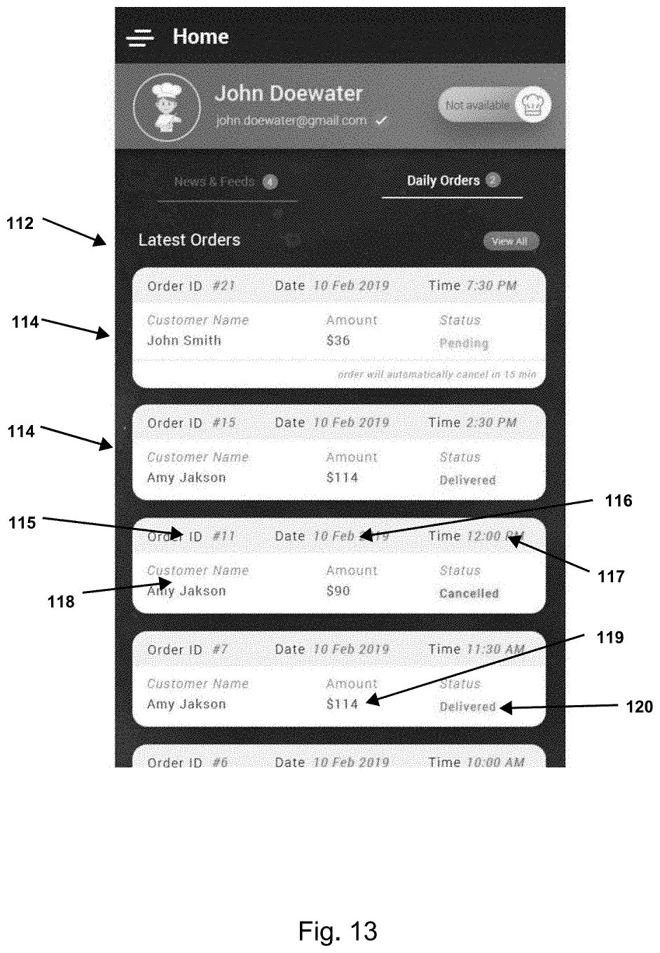

FIG. 14 is a diagram illustrating a user interface for a home screen; the view showing navigation options for a plurality of pages and functions;

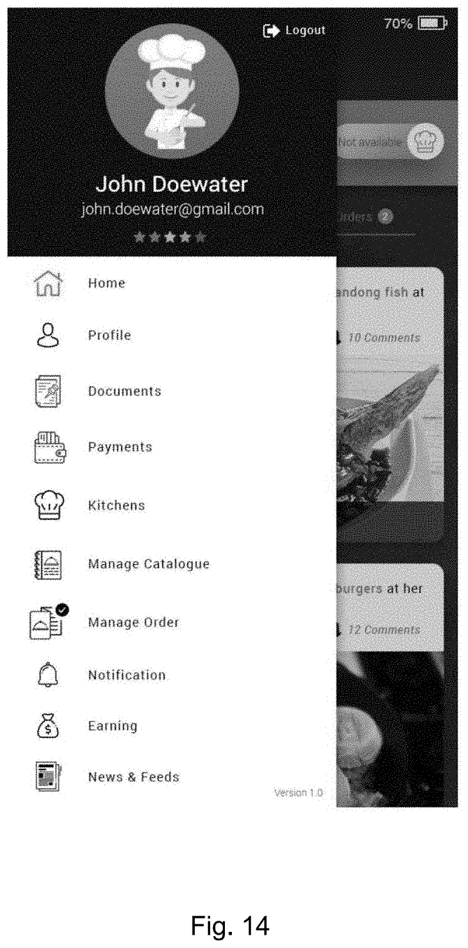

FIG. 15 is a diagram illustrating a user interface for a profile page; the view showing various features of a chef profile page;

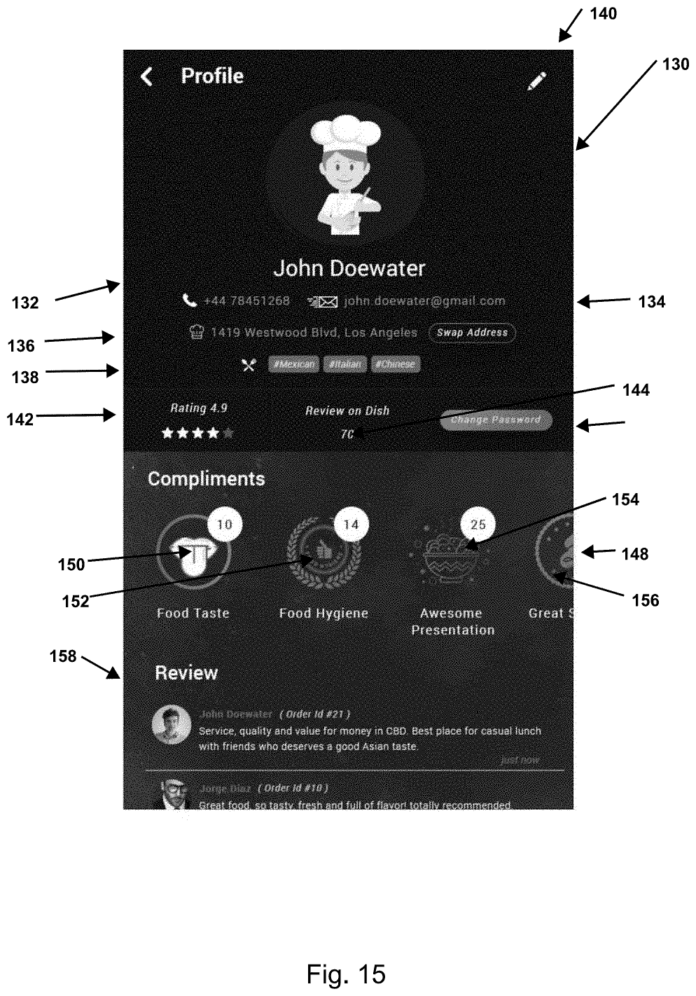

FIG. 16 is a diagram illustrating a user interface for a profile page; the view showing profile data;

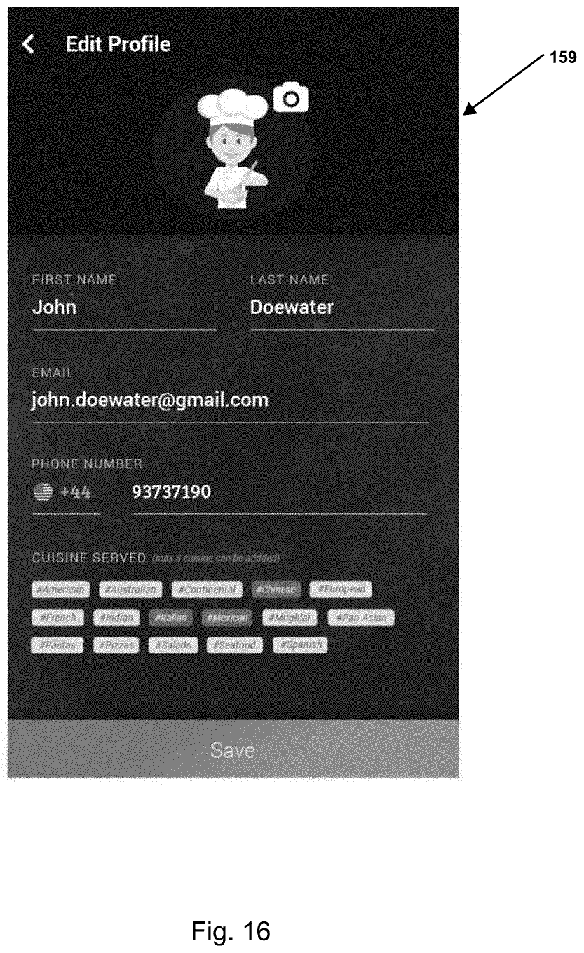

FIG. 17 is a diagram illustrating a user interface for a profile page; the view showing an address add, remove, edit feature;

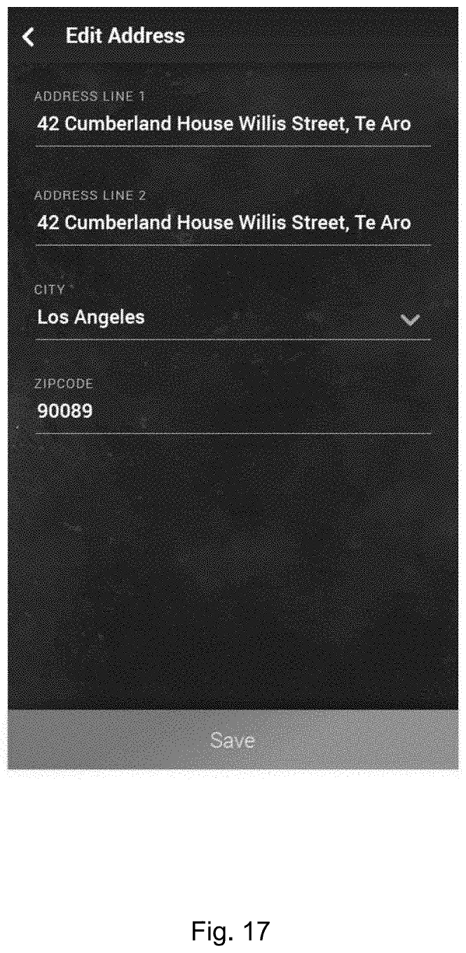

FIG. 18 is a diagram illustrating a user interface for a chef's document page; the view showing various chef document page links and features;

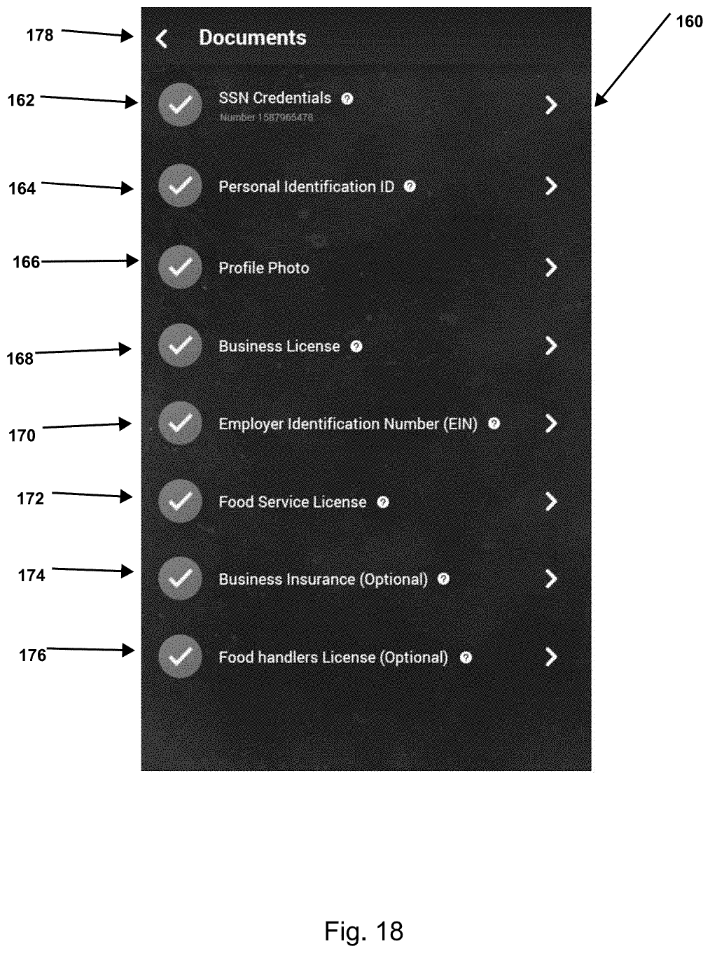

FIG. 19 is a diagram illustrating a user interface for a chef's document page; the view showing various chef document page links and features; the view showing a help tool providing information related to a function;

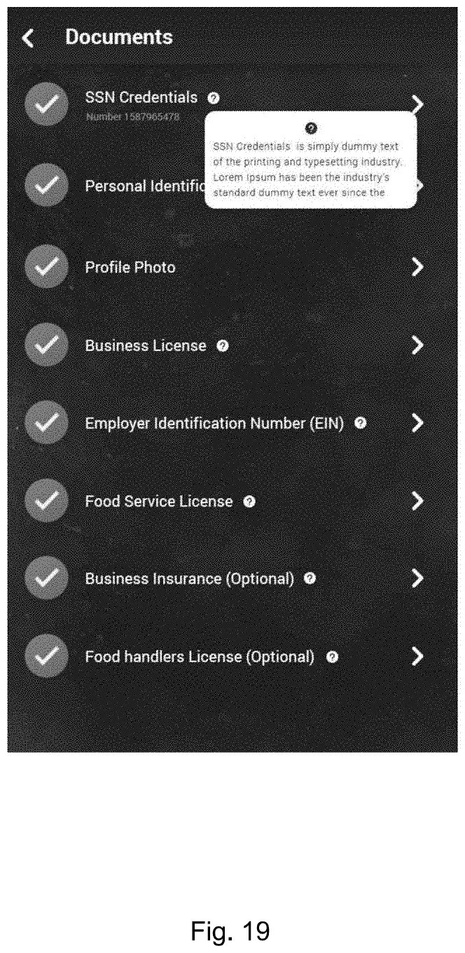

FIG. 20 is a diagram illustrating a user interface for a chef's document page; the view showing an add business license feature;

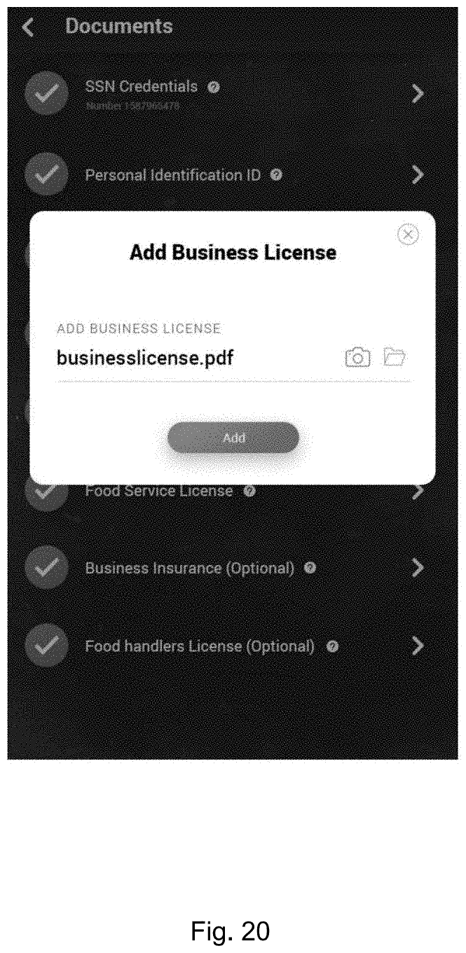

FIG. 21 is a diagram illustrating a user interface of an accounts page; the view showing a payment method page; the view showing various payout edit features; the view showing various payment method features;

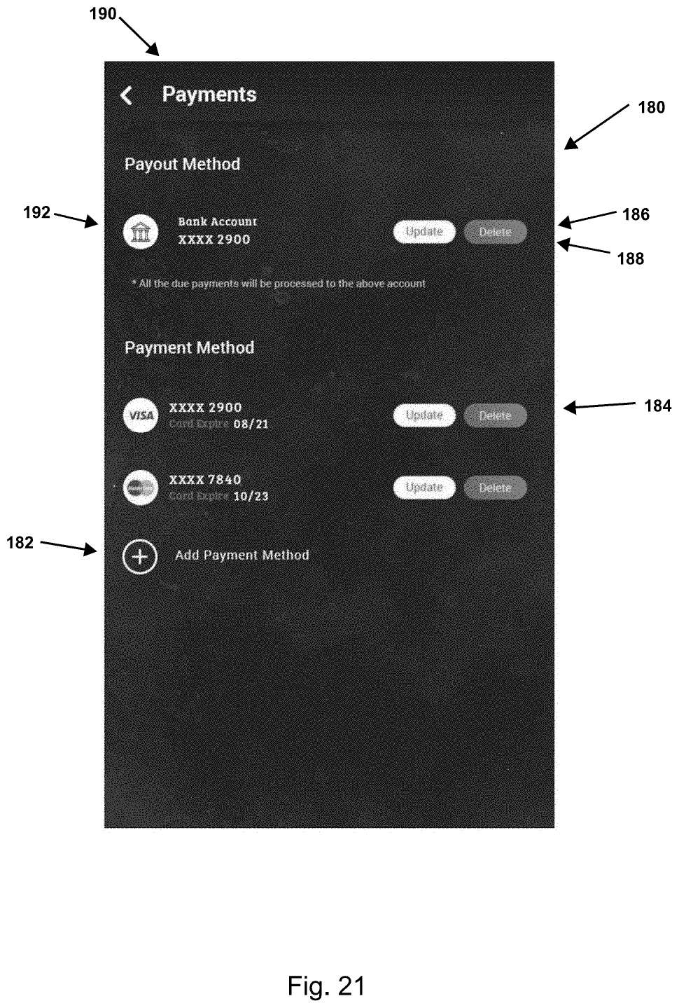

FIG. 22 is a diagram illustrating a user interface for an accounts page; the view showing an add payout feature;

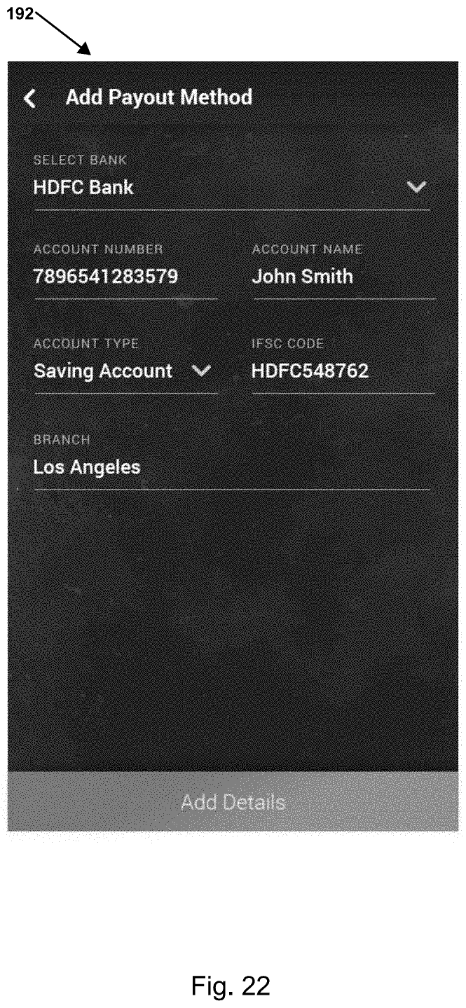

FIG. 23 is a diagram illustrating a user interface for an accounts page; the view showing an add payment feature;

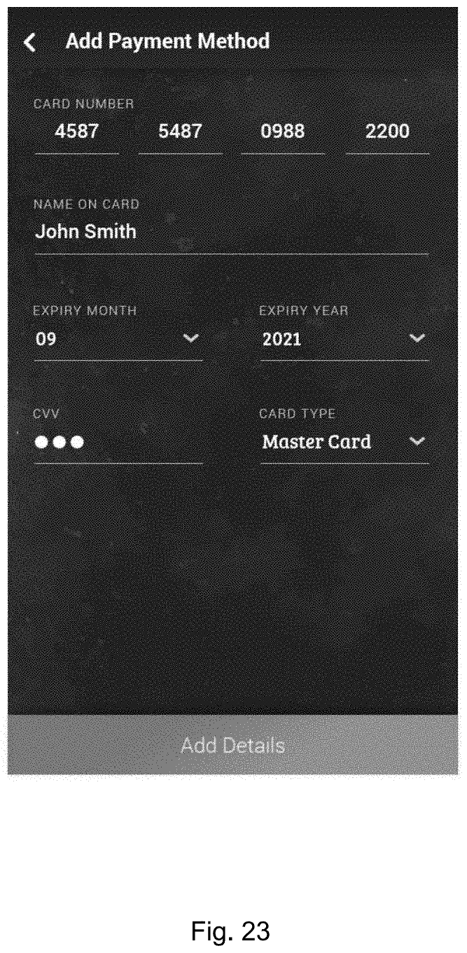

FIG. 24 is a diagram illustrating a user interface of a kitchen page; the view showing a your own kitchen tab; the view showing an add kitchen feature;

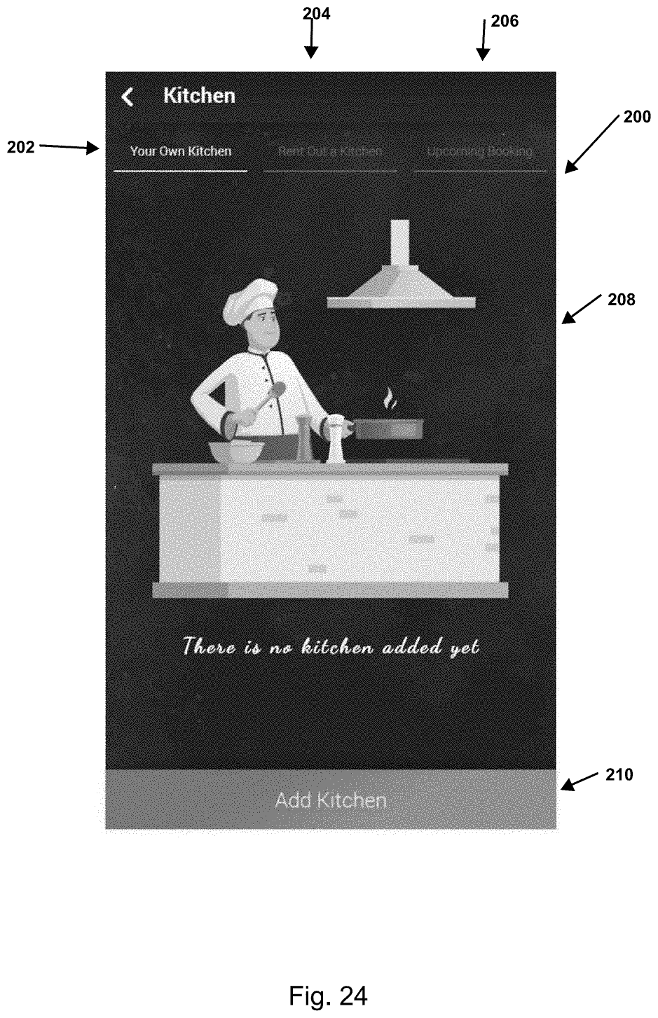

FIG. 25 is a diagram illustrating a user interface of a kitchen page; the view showing an add kitchen feature;

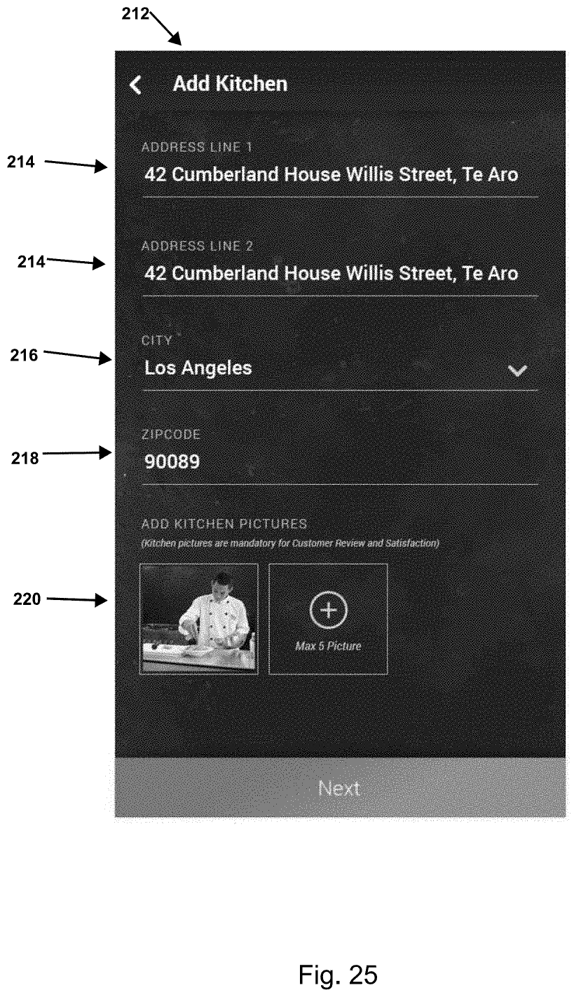

FIG. 26 is a diagram illustrating a user interface of a kitchen page; the view showing an add kitchen documents feature;

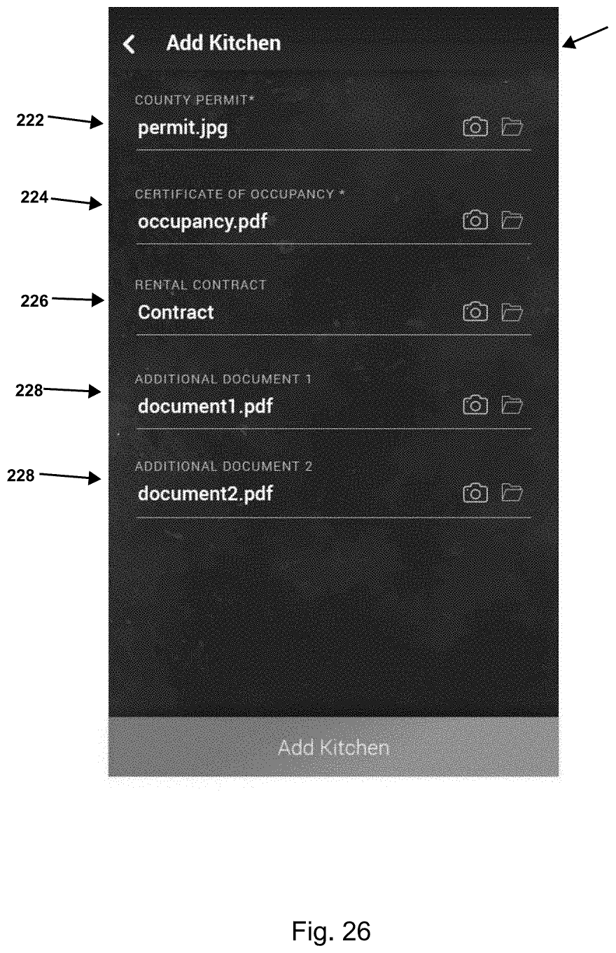

FIG. 27 is a diagram illustrating a user interface of a kitchen page; the view showing a plurality of kitchens;

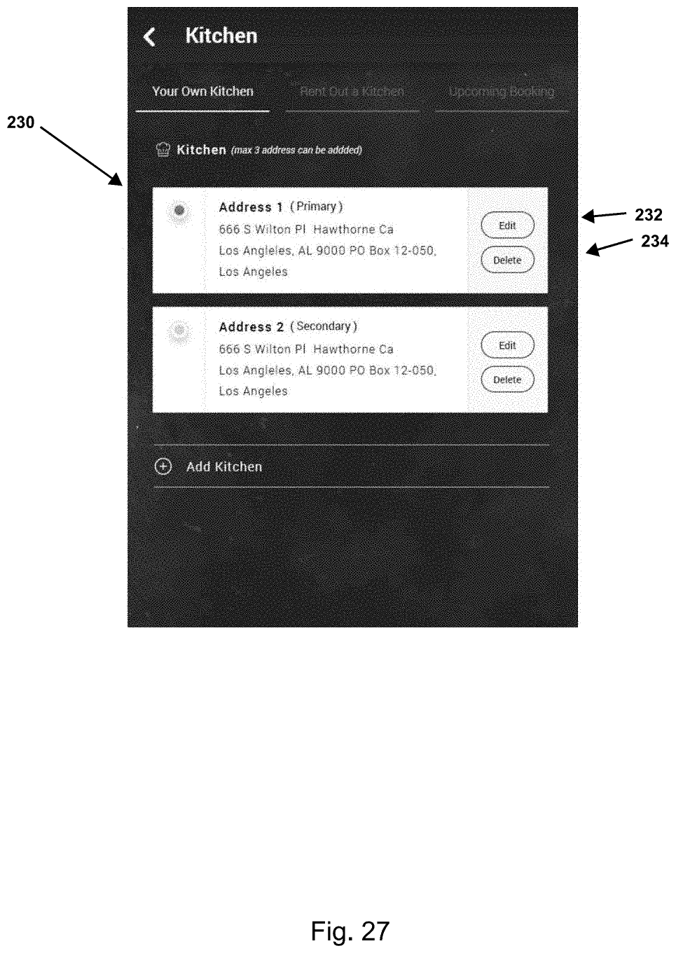

FIG. 28 is a diagram illustrating a user interface of a kitchen page; the view showing a plurality of kitchens; the view showing a plurality of active kitchens; the view showing notifications;

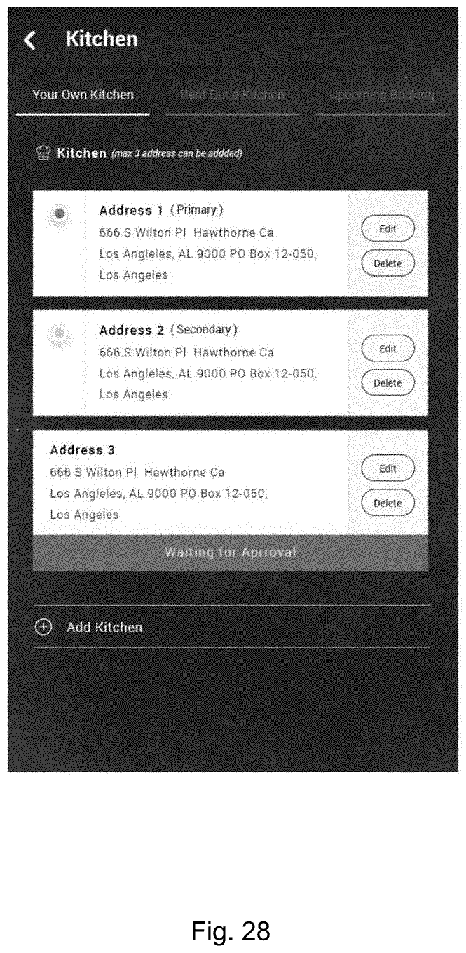

FIG. 29 is a diagram illustrating a user interface for a kitchen page; the view showing a plurality of kitchens available for rent under the rent out a kitchen tab;

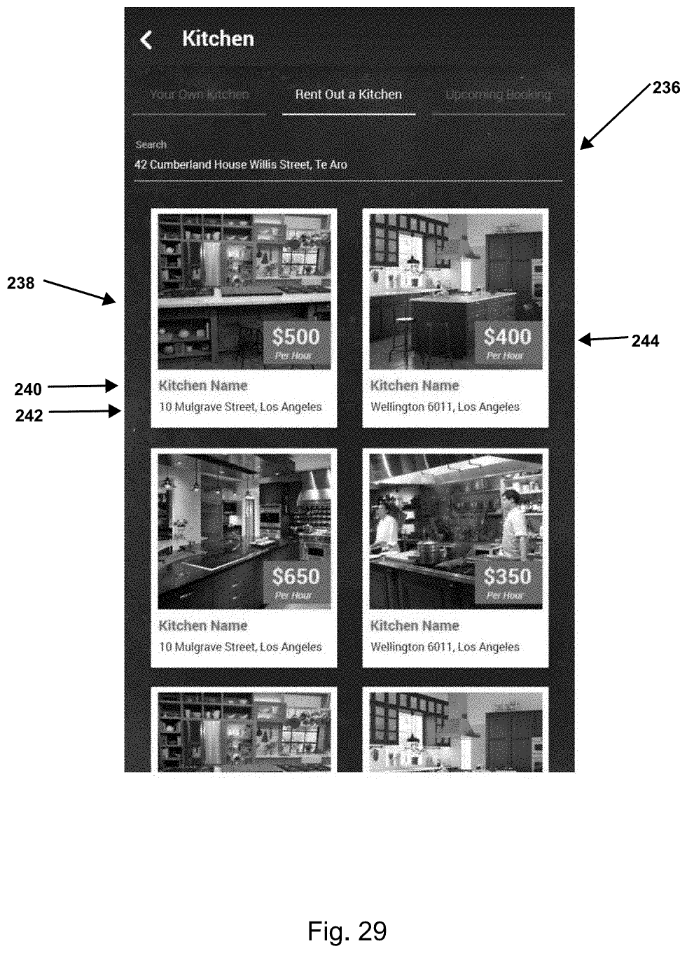

FIG. 30 is a diagram illustrating a user interface for a kitchen page; the view showing a kitchen with a price; the view showing a check availability feature; the view showing a send request feature;

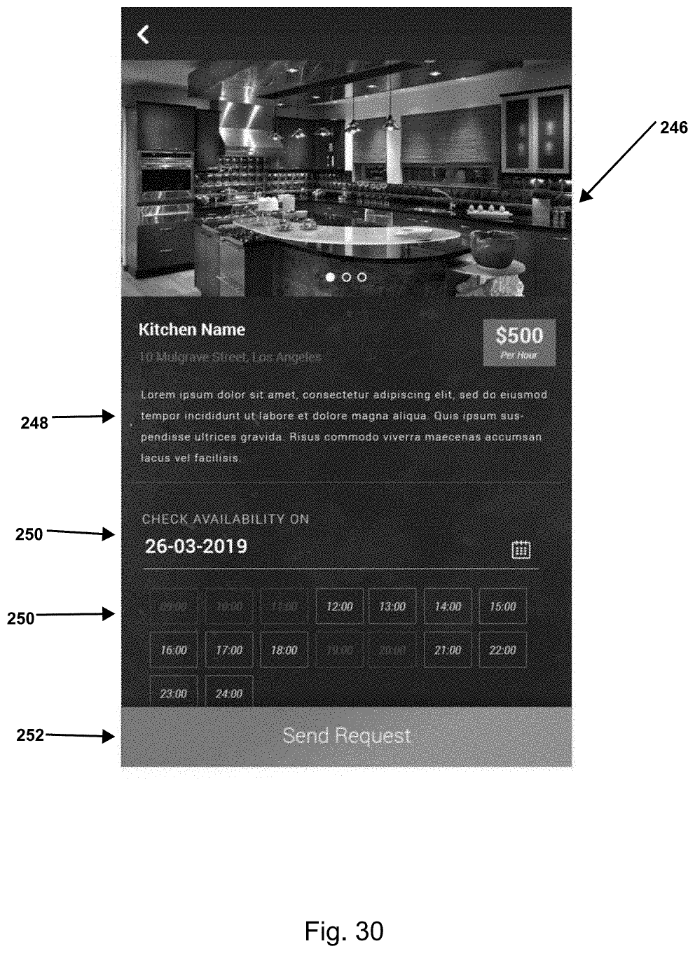

FIG. 31 is a diagram illustrating a user interface for a kitchen page; the view showing a kitchen with a price; the view showing a check availability feature; the view showing a send request feature; the view showing a check availability feature of times and dates selected for an availability check;

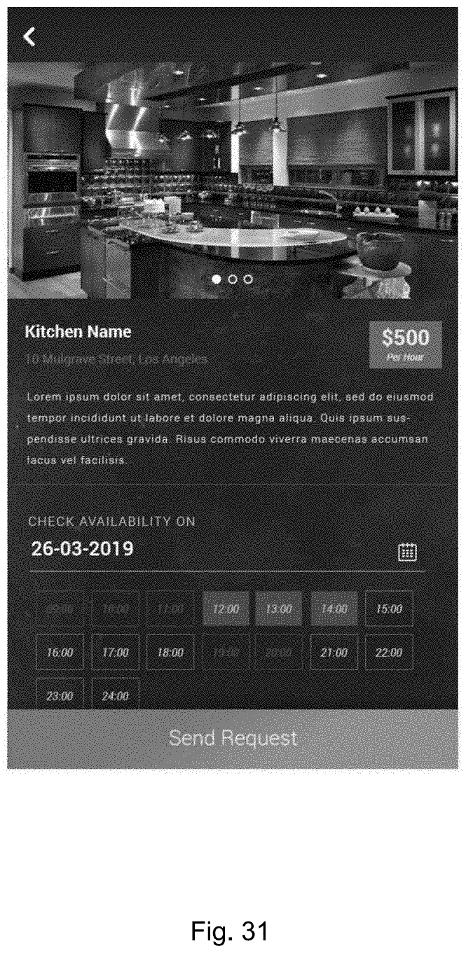

FIG. 32 is a diagram illustrating a user interface for a kitchen page; the view showing a payment method feature for renting a kitchen; the view showing booking times; the view showing date; the view showing cost; the view showing a select payment feature; the view showing an add payment feature; the view showing a make payment feature;

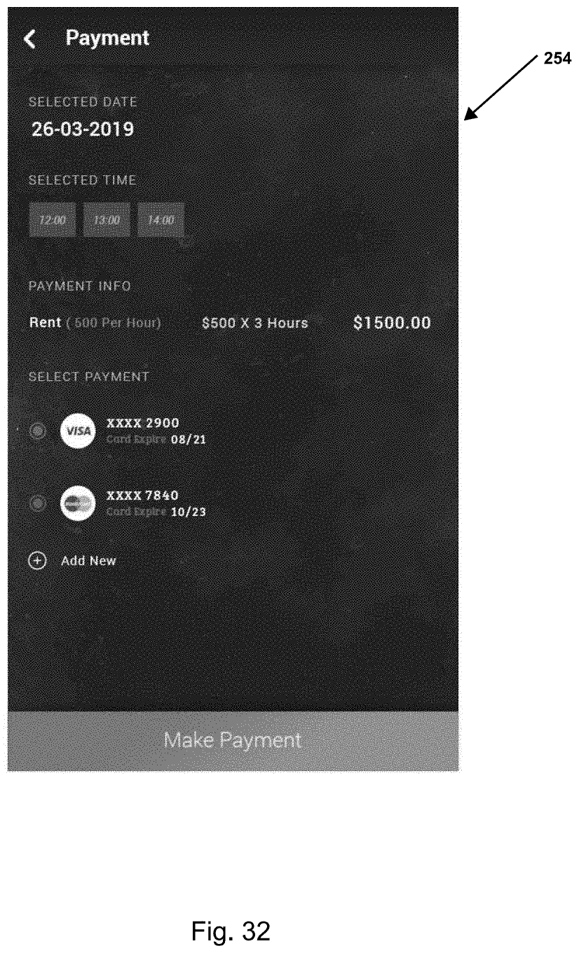

FIG. 33 is a diagram illustrating a user interface for a kitchen page; the view showing a kitchen with a price; the view showing a check availability feature; the view showing a send request feature; the view showing a check availability feature of times and dates selected for an availability check;

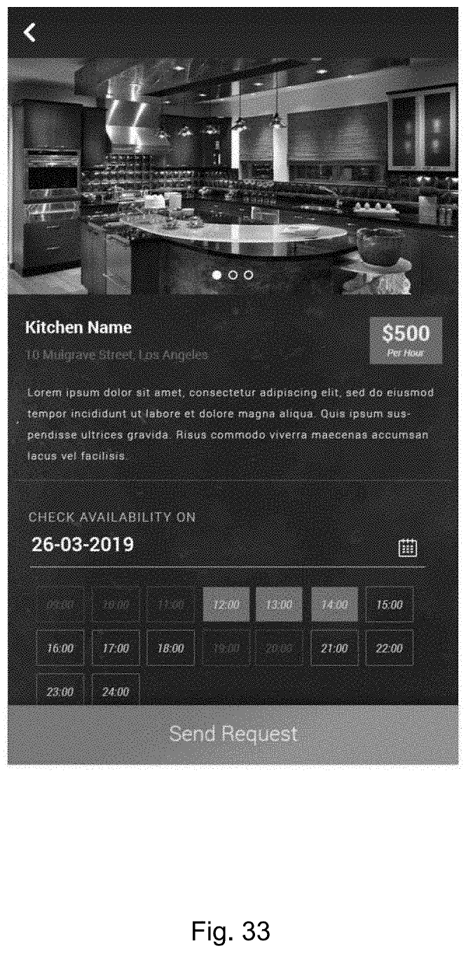

FIG. 34 is a diagram illustrating a user interface for a kitchen page; the view showing a kitchen with a price; the view showing a check availability feature; the view showing a send request feature; the view showing a check availability feature of times and dates selected for an availability check;

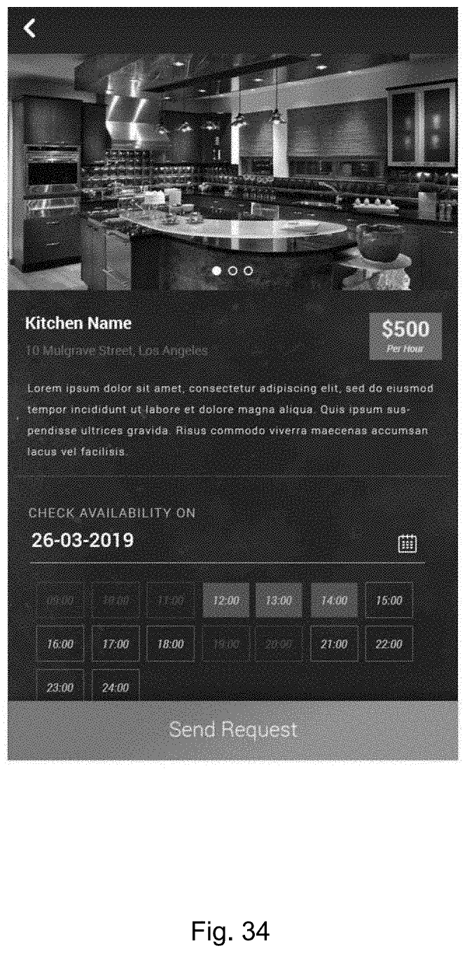

FIG. 35 is a diagram illustrating a user interface for a kitchen page; the view showing an upcoming booking tab; the view showing, a plurality of bookings;

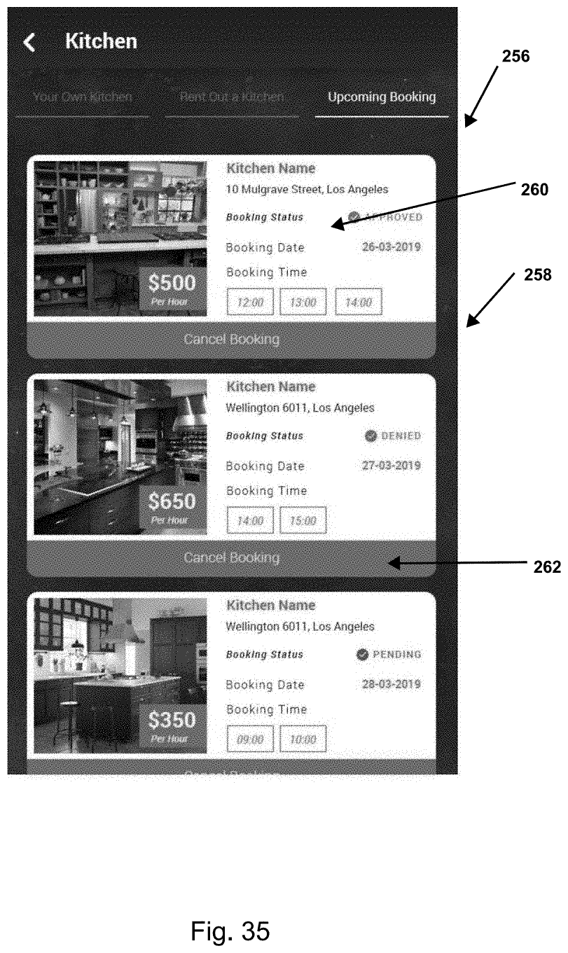

FIG. 36 is a diagram illustrating a user interface for a kitchen page; the view showing an upcoming booking tab; the view showing a cancel booking feature;

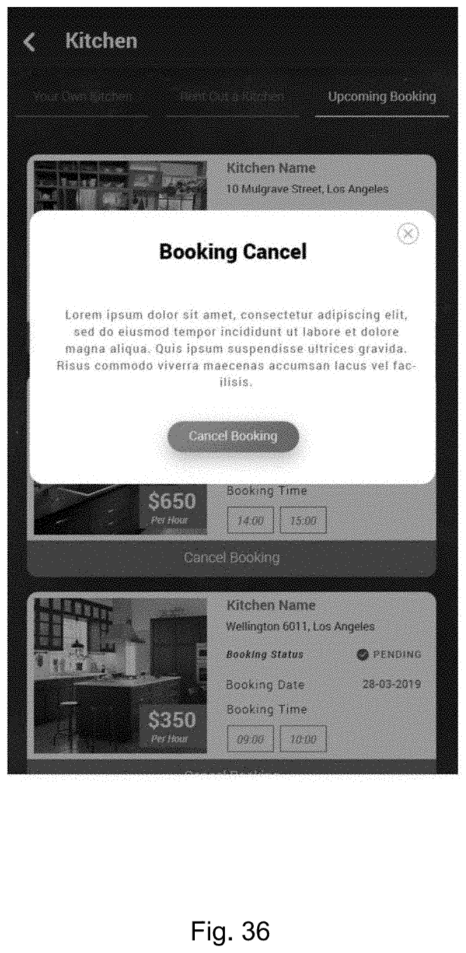

FIG. 37 is a diagram illustrating a user interface for a manage catalogue page; the view showing a categories tab; the view showing a plurality of categories; the view showing a plurality of functions and features associated with a plurality of categories; the view showing an add category feature;

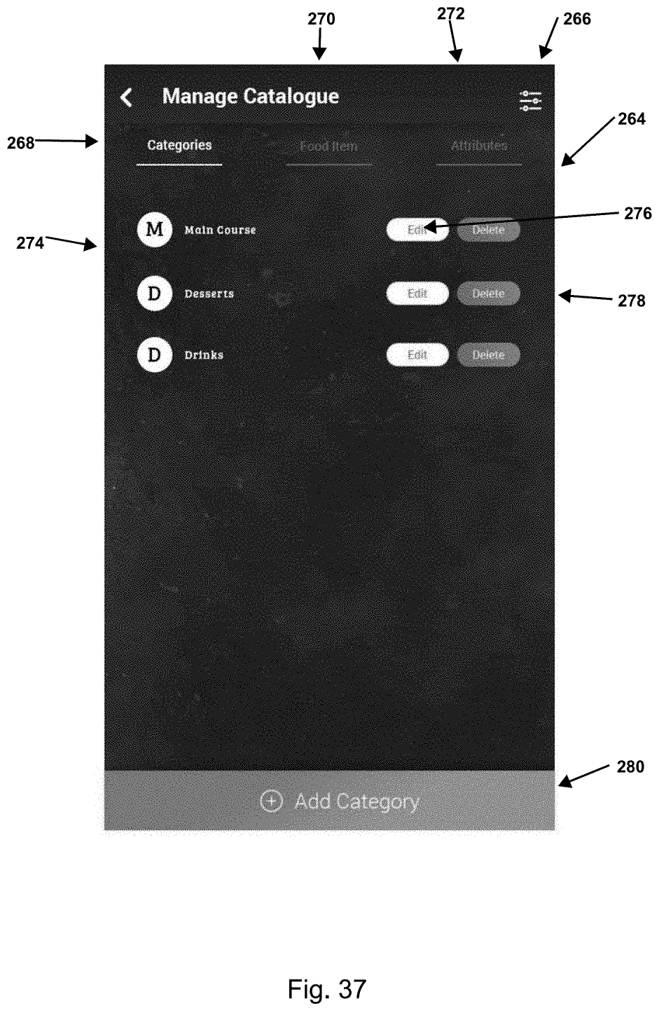

FIG. 38 is a diagram illustrating a user interface for a manage catalogue page; the view showing a create category feature; the view showing category input;

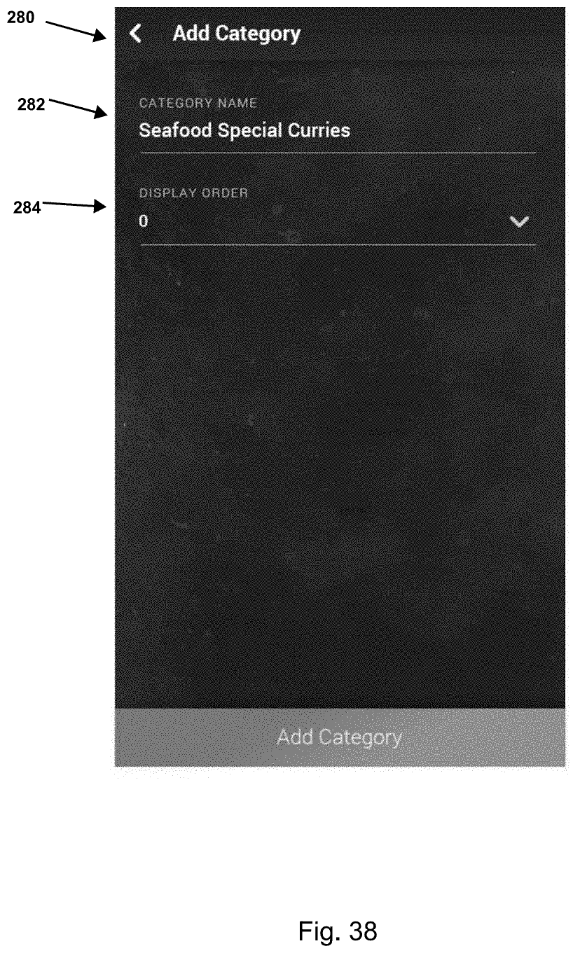

FIG. 39 is a diagram illustrating a user interface for a manage catalogue page; the view showing a food item tab; the view showing an add food item feature;

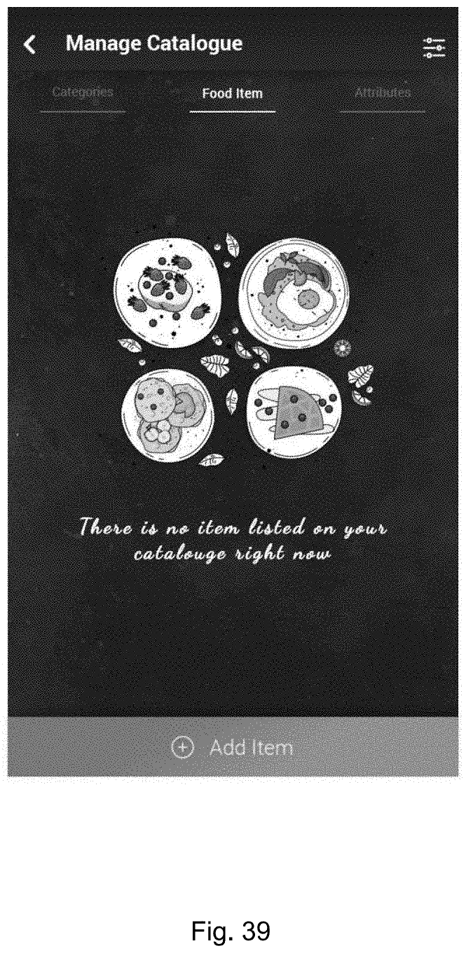

FIG. 40 is a diagram illustrating a user interface for a manage catalogue page; the view showing a food item tab; the view showing an add food item feature; the view showing a plurality of food items;

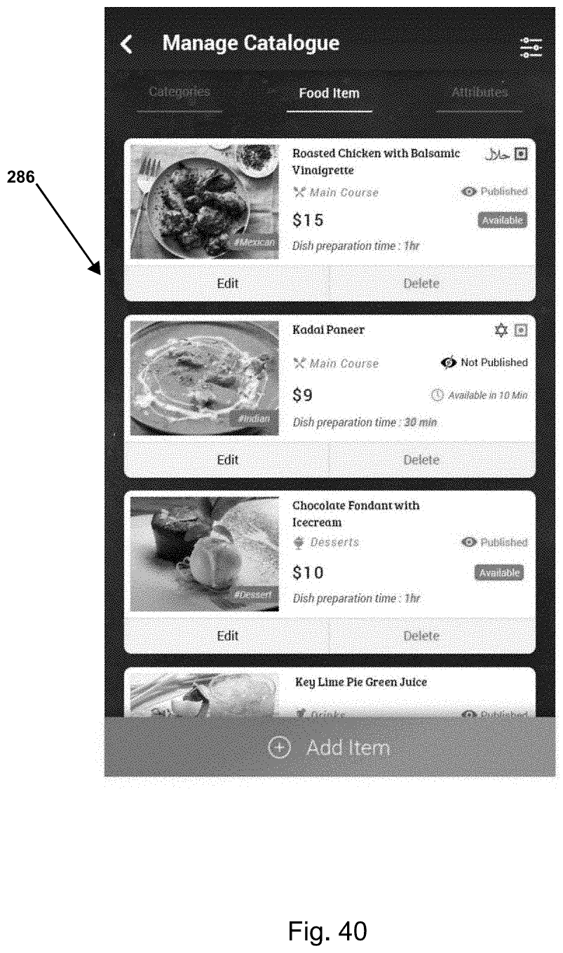

FIG. 41 is a diagram illustrating a user interface for a manage catalogue page; the view showing a food item tab; the view showing an add food item feature; the view showing a plurality of food items; the view showing a product name search feature; the view showing a filter feature;

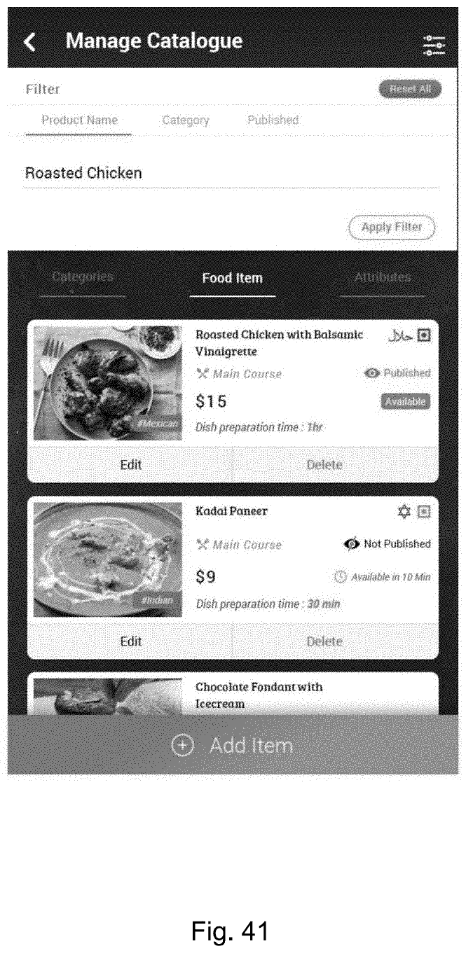

FIG. 42 is a diagram illustrating a user interface for a manage catalogue page; the view showing a food hem tab; the view showing an add food item feature; the view showing a plurality of food items; the view showing a category search feature; the view showing a filter feature;

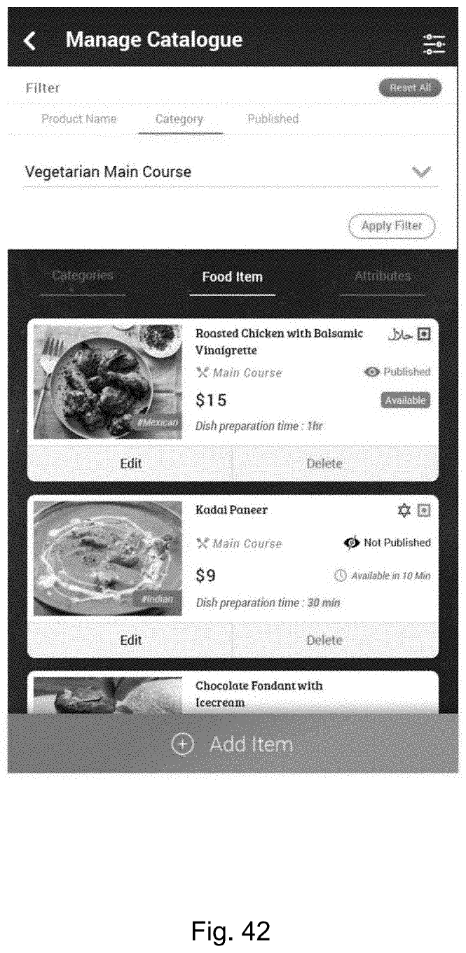

FIG. 43 is a diagram illustrating a user interface for a manage catalogue page; the view showing a food item tab; the view showing an add food item feature; the view showing a plurality of food items; the view showing a published search feature; the view showing a filter feature;

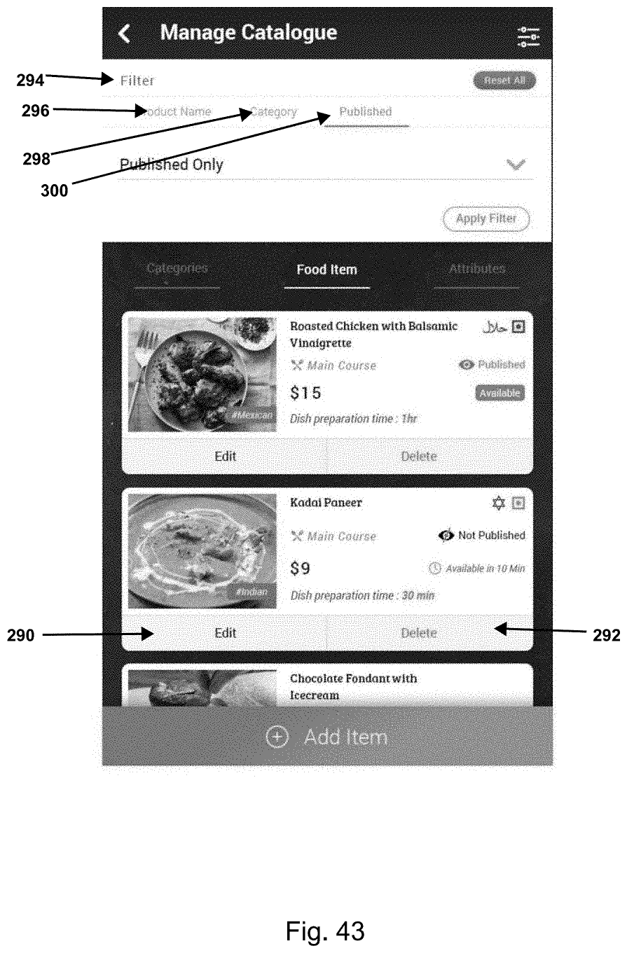

FIG. 44 is a diagram illustrating a user interface for a manage catalogue page; the view showing a food item creation page; the view showing a plurality of attributes; the view showing an add item feature;

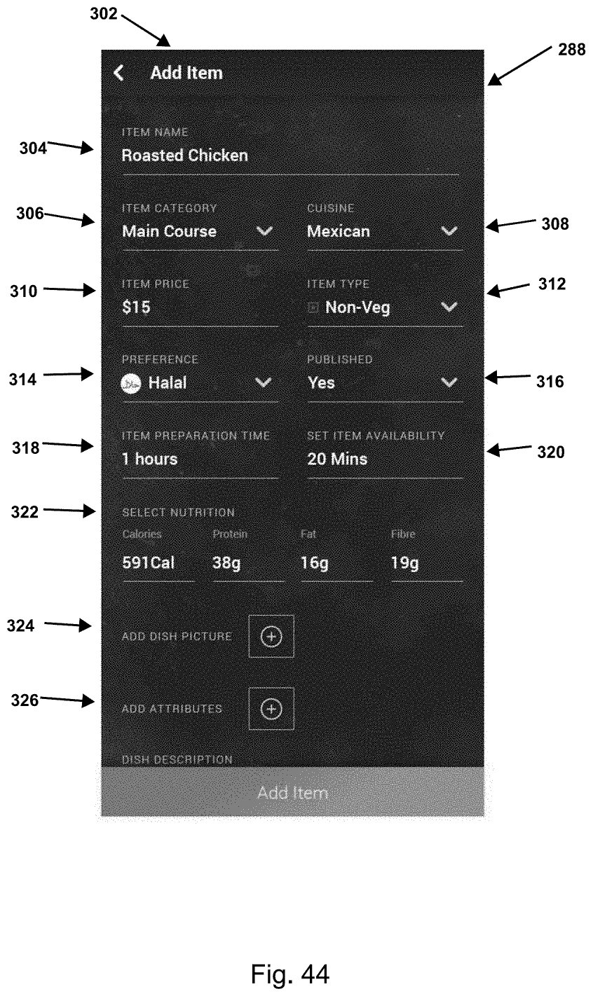

FIG. 45 is a diagram illustrating a user interface for a manage catalogue page; the view showing a food item creation page; the view showing a plurality of attributes; the view showing an add item feature; the view showing an add attributes feature;

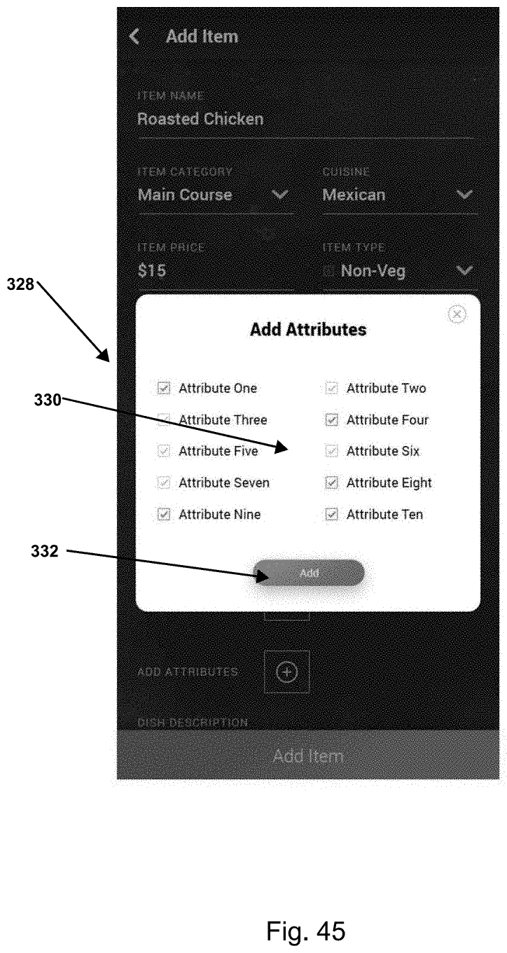

FIG. 46 is a diagram illustrating a user interface for a manage catalogue page; the view showing a food item creation page; the view showing a plurality of attributes; the view showing an add item feature; the view showing an attributes tab;

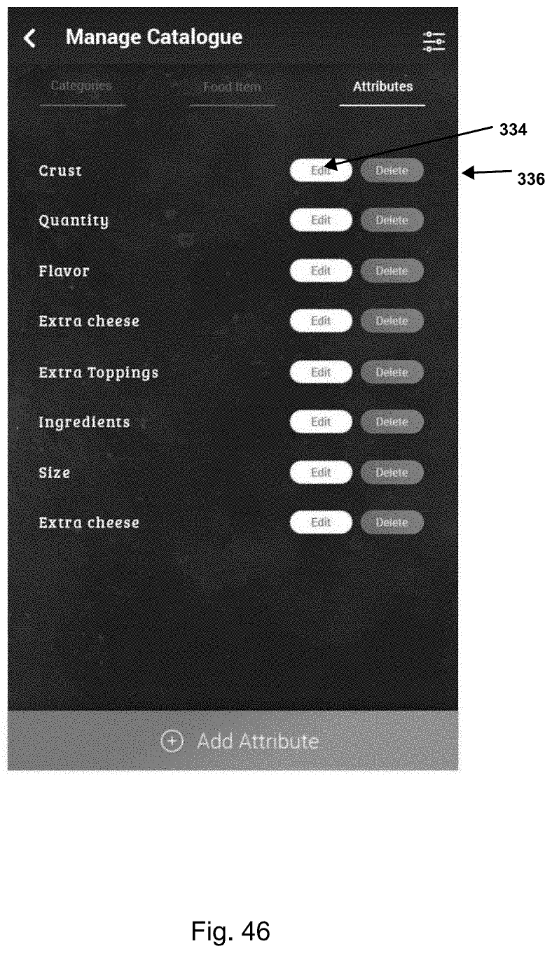

FIG. 47 is a diagram illustrating a user interface for a manage catalogue page; the view showing a create attribute page; the view showing a plurality of attribute qualities;

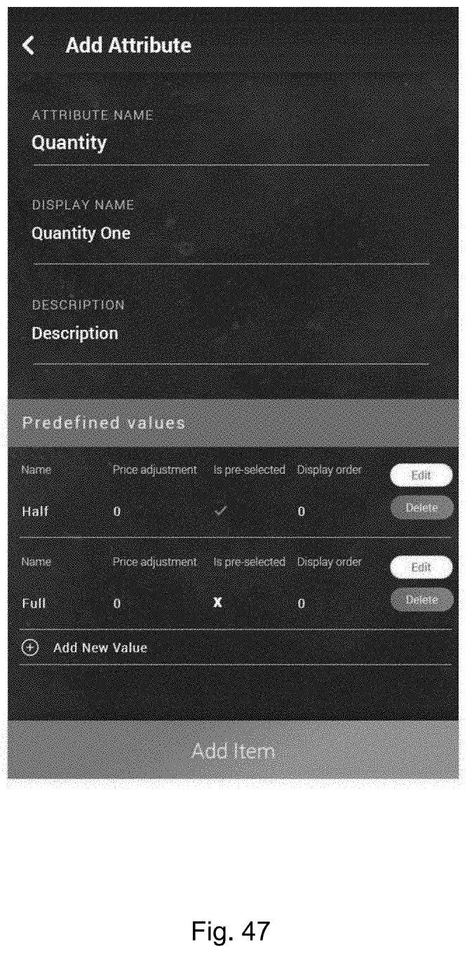

FIG. 48 is a diagram illustrating a user interface for a manage catalogue page; the view showing a create attribute page; the view showing a plurality of attribute qualities; the view showing an add new value feature;

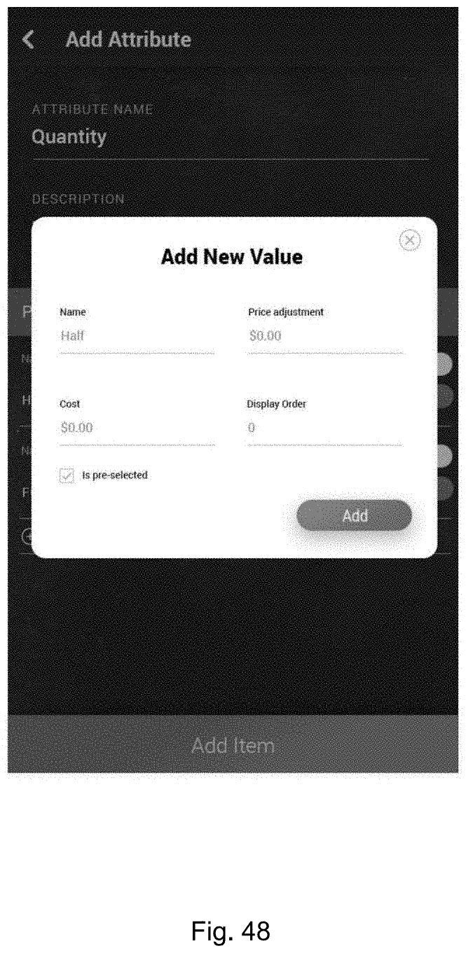

FIG. 49 is a diagram illustrating a user interface for a manage orders page; the view showing, a current orders tab;

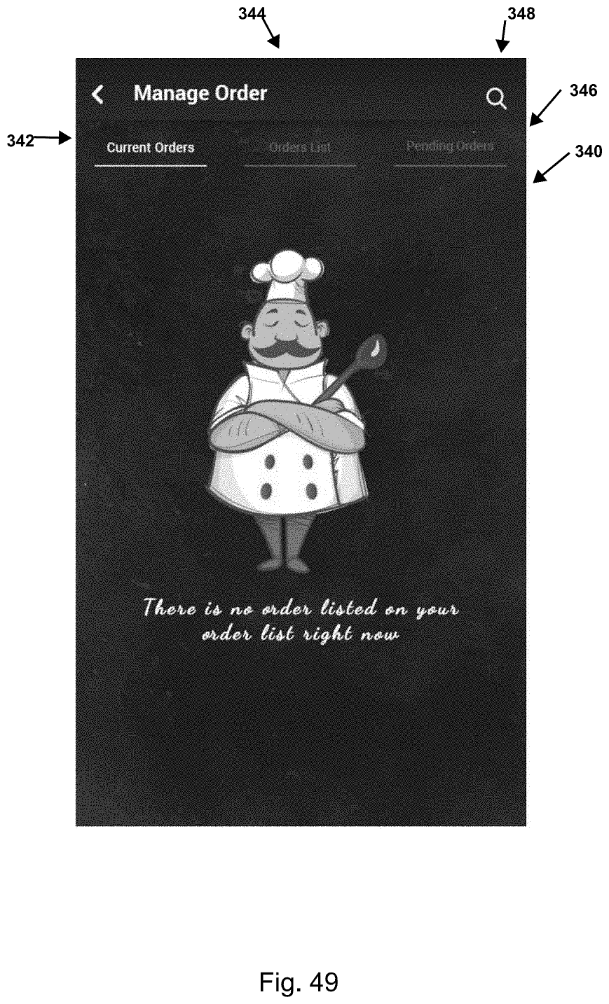

FIG. 50 is a diagram illustrating a user interface for a manage orders page; the view showing a current orders tab; the view showing a plurality of current orders;

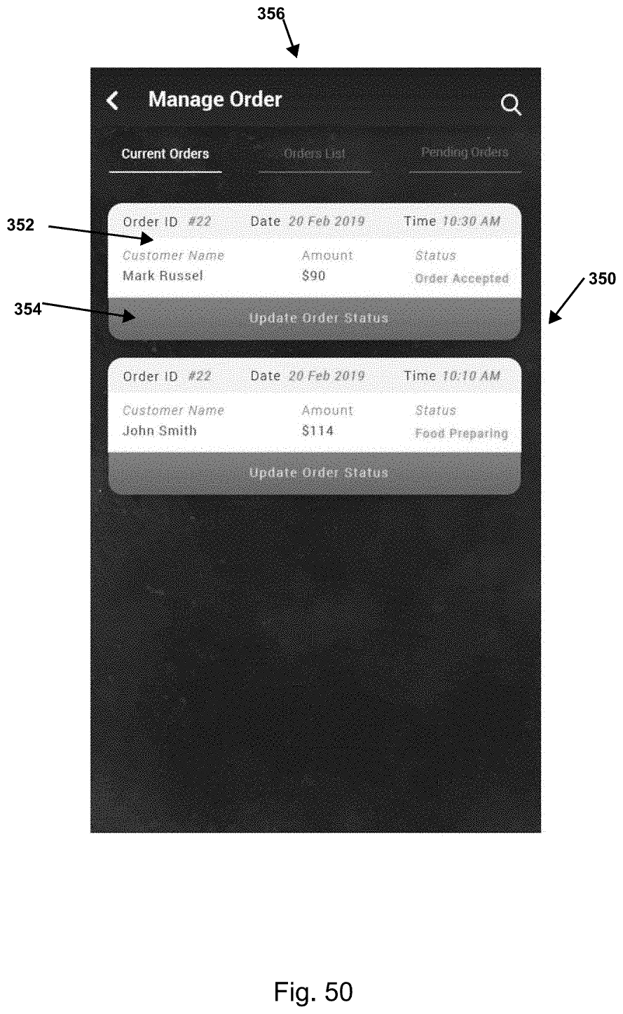

FIG. 51 is a diagram illustrating a user interface for a manage orders page; the view showing an orders list tab; the view showing a date search feature; the view showing a date range feature; the view showing a plurality of orders; the view showing a plurality of order identifiers; the view showing a day of the week;

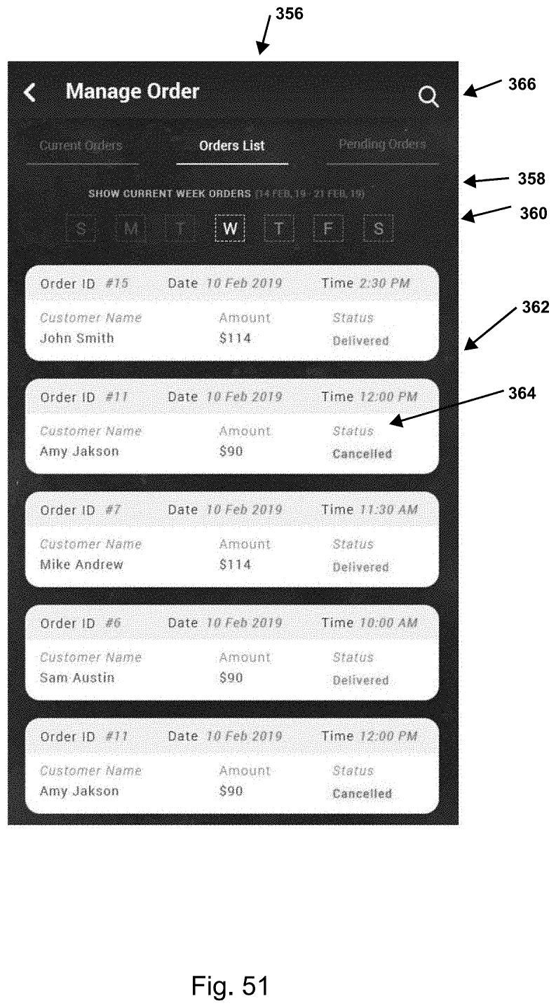

FIG. 52 is a diagram illustrating a user interface for a manage orders page; the view showing an orders list tab; the view showing a date search feature; the view showing a date range feature; the view showing a plurality of orders; the view showing a plurality of order identifiers; the view showing a day of the week; the view showing an order identification search feature;

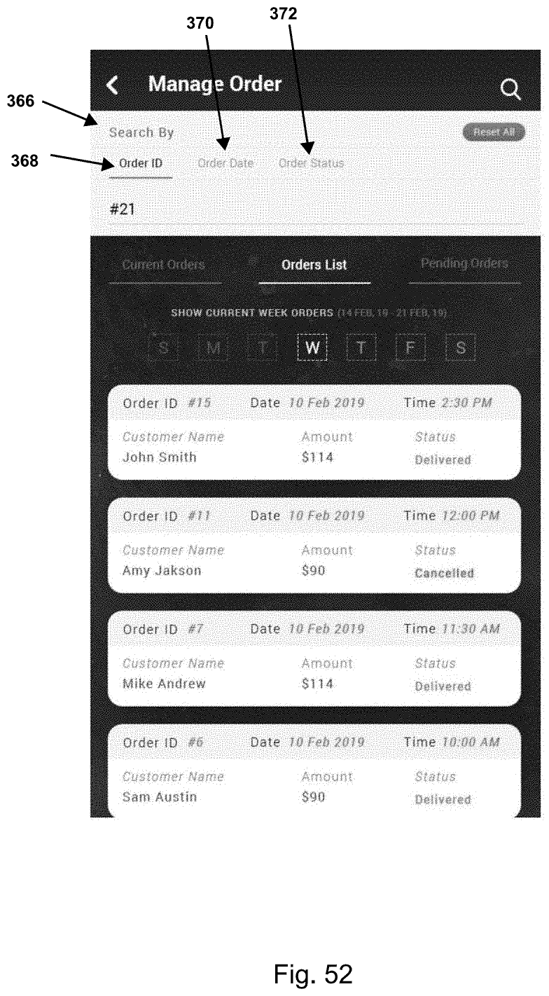

FIG. 53 is a diagram illustrating a user interface for a manage orders page; the view showing an orders list tab; the view showing a date search feature; the view showing a date range feature; the view showing a plurality of orders; the view showing a plurality of order identifiers; the view showing a day of the week; the view showing an order identification search feature;

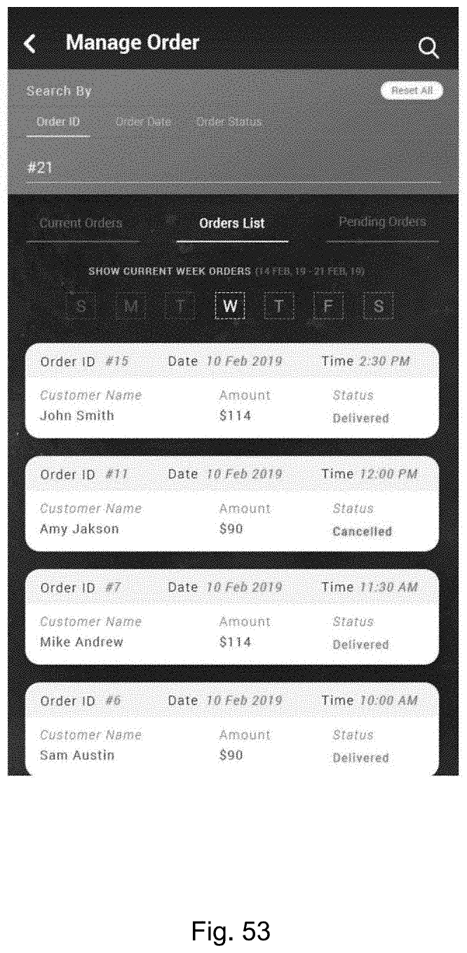

FIG. 54 is a diagram illustrating a user interface for an order details page; the view showing order identification criteria; the view showing order status; the view showing a graphical process display for the order; the view showing an order summary;

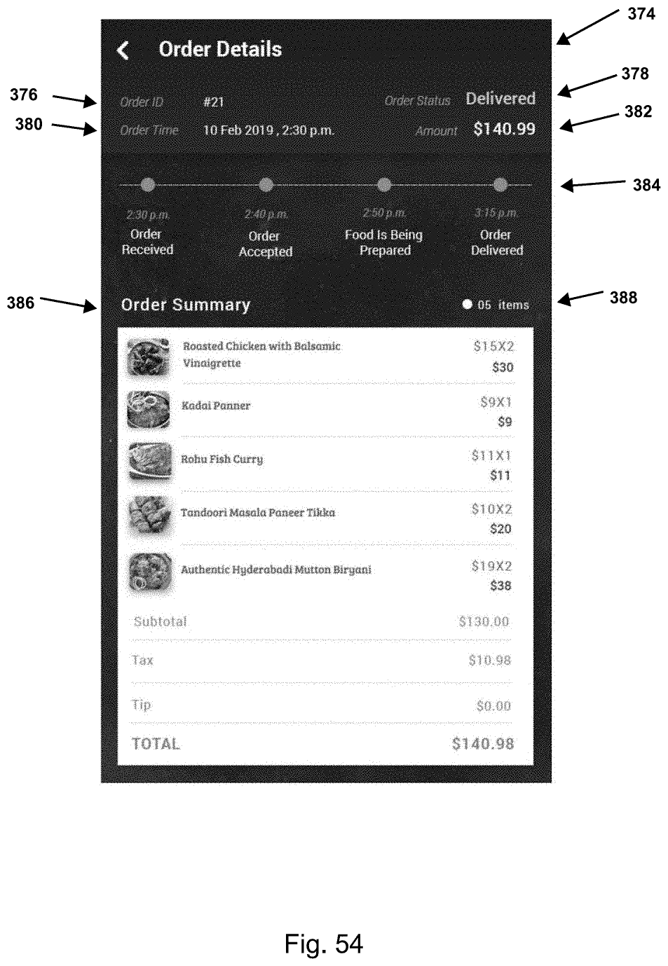

FIG. 55 is a diagram illustrating a user interface for a manage orders page; the view showing a current orders tab; the view showing a plurality of orders; the view showing a new order notification feature;

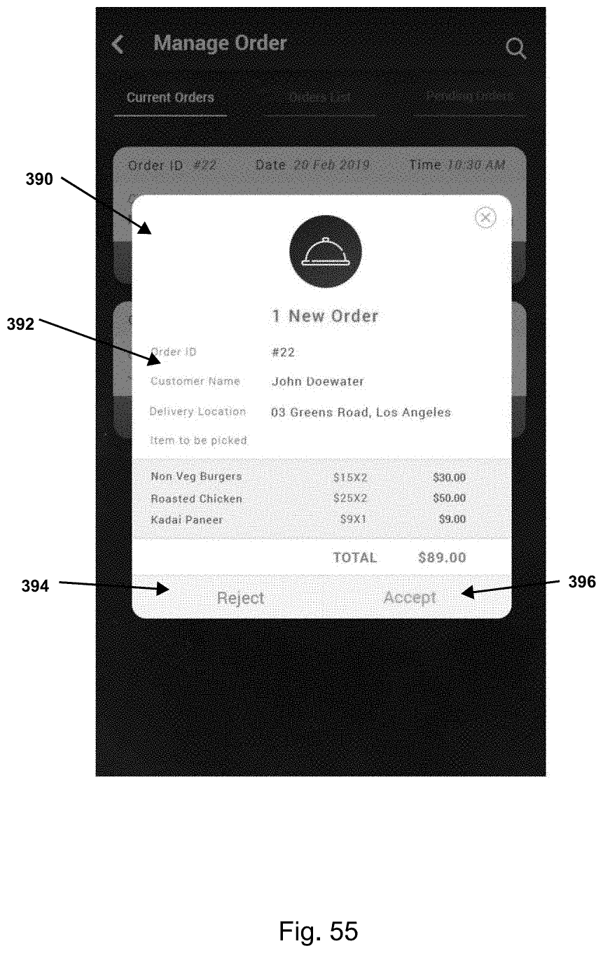

FIG. 56 is a diagram illustrating a user interface for a manage orders page; the view showing a current orders tab; the view showing a plurality of orders; the view showing an order status notification feature; the view showing an order status change feature;

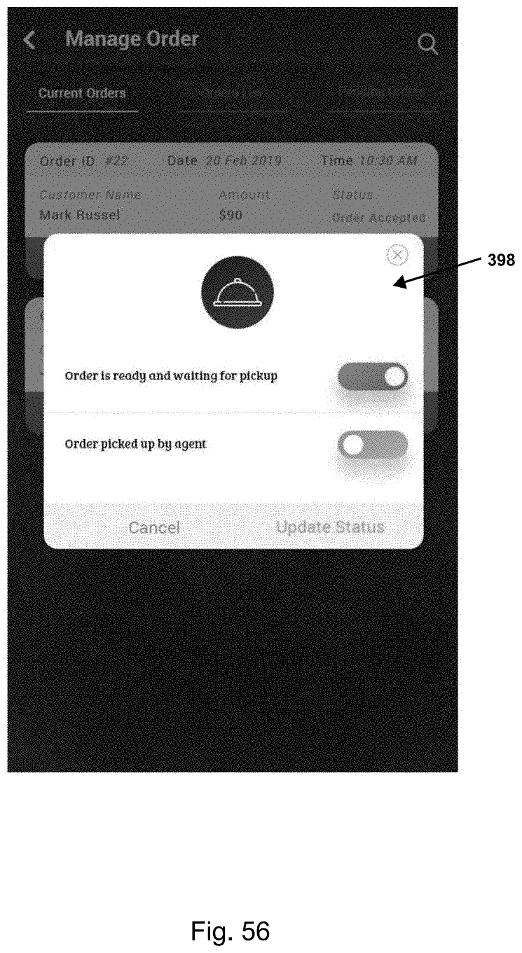

FIG. 57 is a diagram illustrating a user interface for a notification page; the view showing a plurality of notifications;

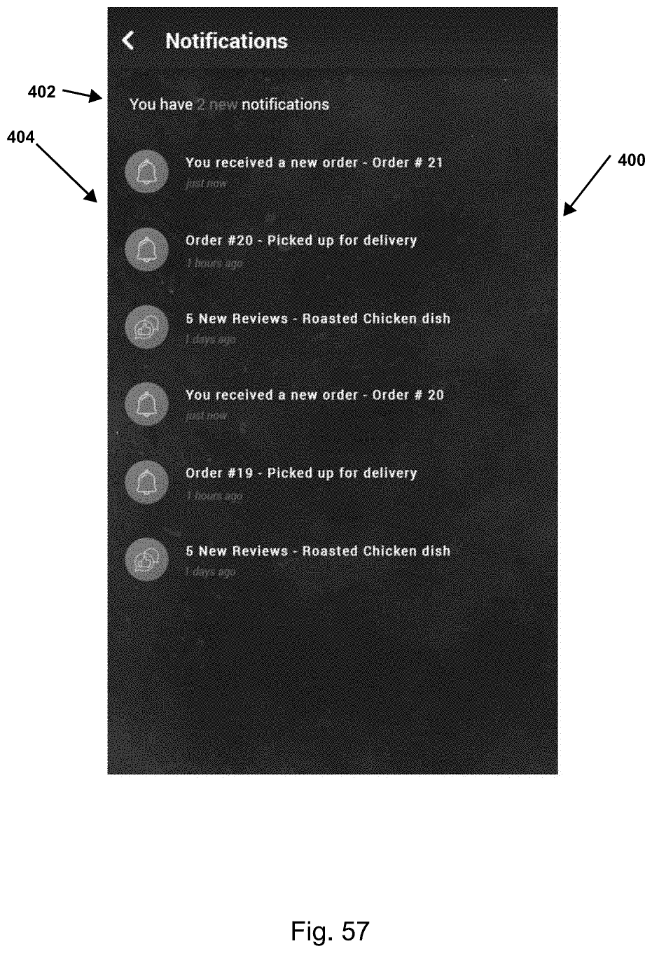

FIG. 58 is a diagram illustrating a user interface for an earnings page; the view showing a current earning;

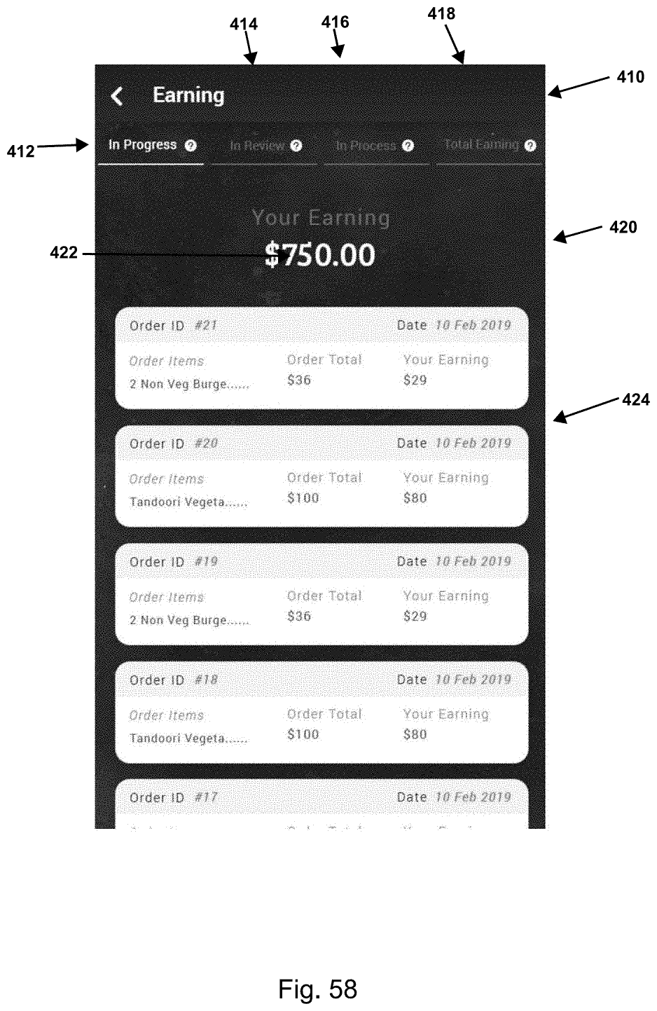

FIG. 59 is a diagram illustrating a user interface for an accounts page; the view showing an in progress tab; the view showing an earnings; the view showing a current earning; the view showing a plurality of associated orders to the earnings category; the view showing a help feature;

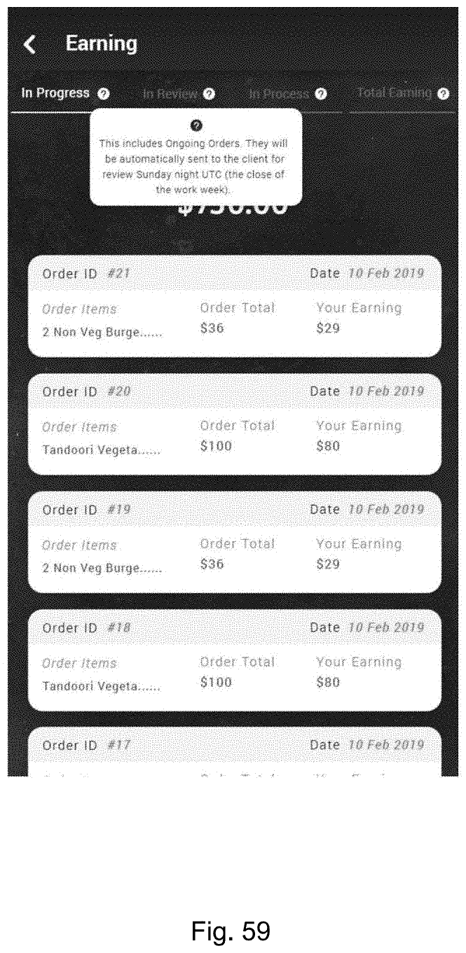

FIG. 60 is a diagram illustrating a user interface for an accounts page; the view showing an in progress tab; the view showing an earnings; the view showing a current earning; the view showing a plurality of associated orders to the earnings category; the view showing a help feature;

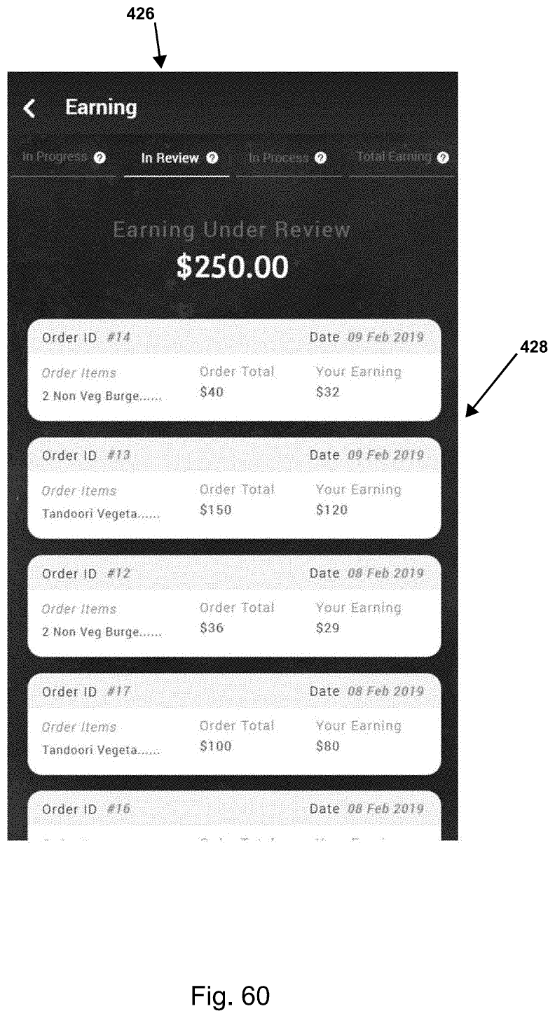

FIG. 61 is a diagram illustrating a user interface for an accounts page; the view showing an in review tab; the view showing an earnings under review; the view showing an in review earning; the view showing a plurality of associated orders to the earnings category; the view showing a help feature;

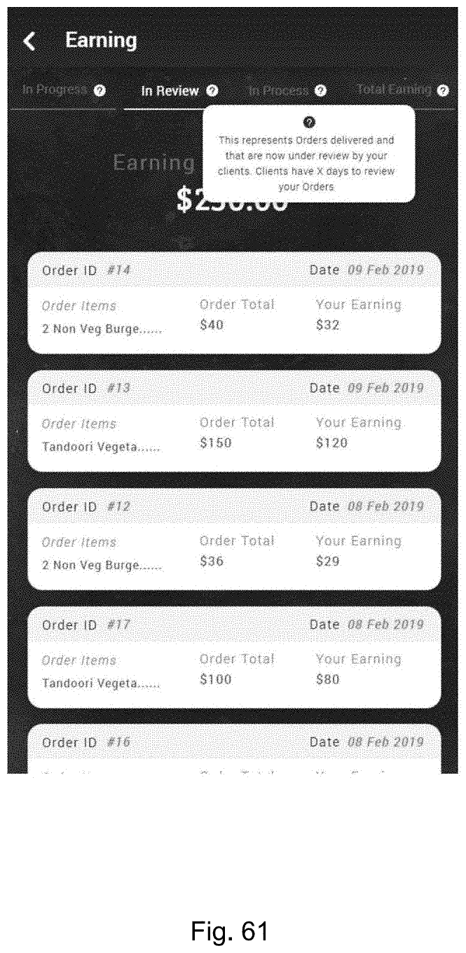

FIG. 62 is a diagram illustrating a user interface for an accounts page; the view showing an in review tab; the view showing an earnings under review; the view showing an in review earning; the view showing a plurality of associated orders to the earnings category; the view showing a help feature;

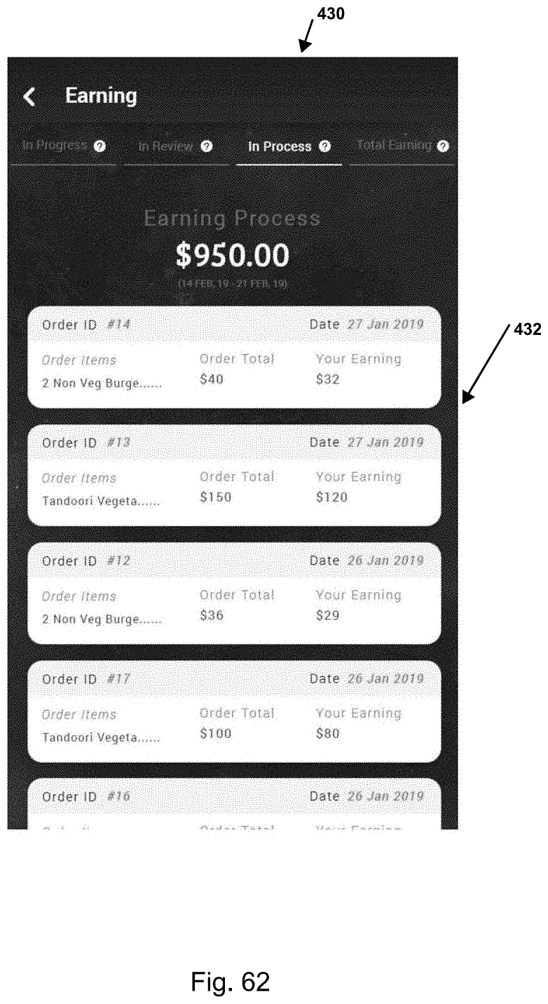

FIG. 63 is a diagram illustrating a user interface for an accounts page; the view showing an in process tab; the view showing an earnings in process; the view showing an, in process earning; the view showing a plurality of associated orders to the earnings category; the view showing a help feature;

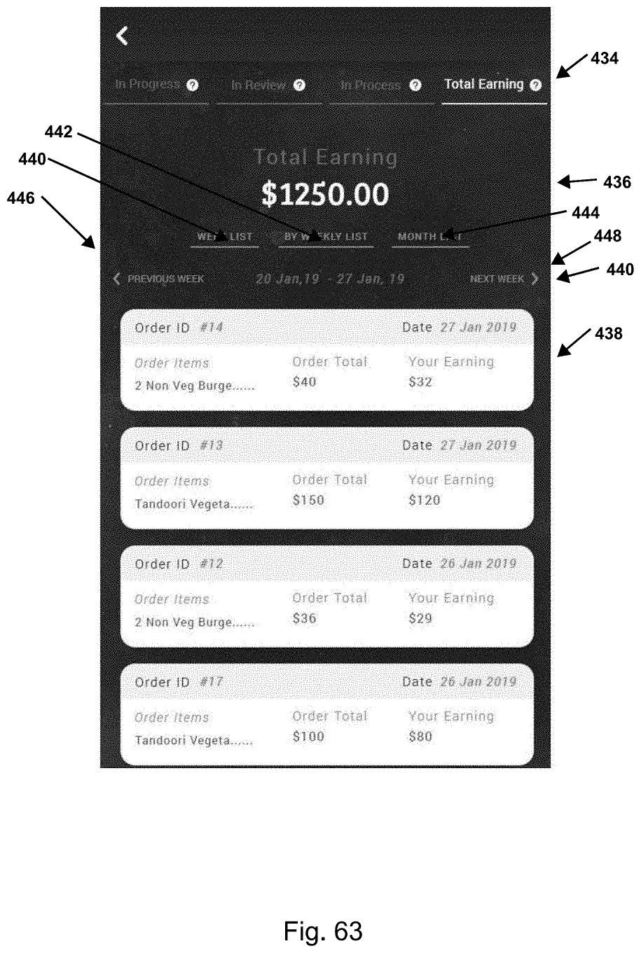

FIG. 64 is a diagram illustrating a user interface for an order details page; the view showing, order identification criteria; the view showing order status; the view showing a graphical process display for the order; the view showing an order summary;

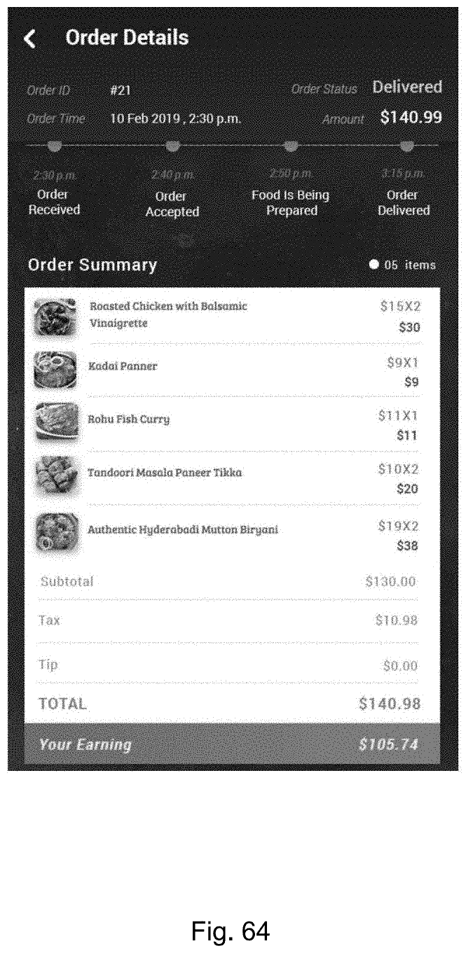

FIG. 65 is a diagram illustrating a user interface for a news & feed page; the view showing a plurality of news and/or feeds; the view showing an add news & feed feature;

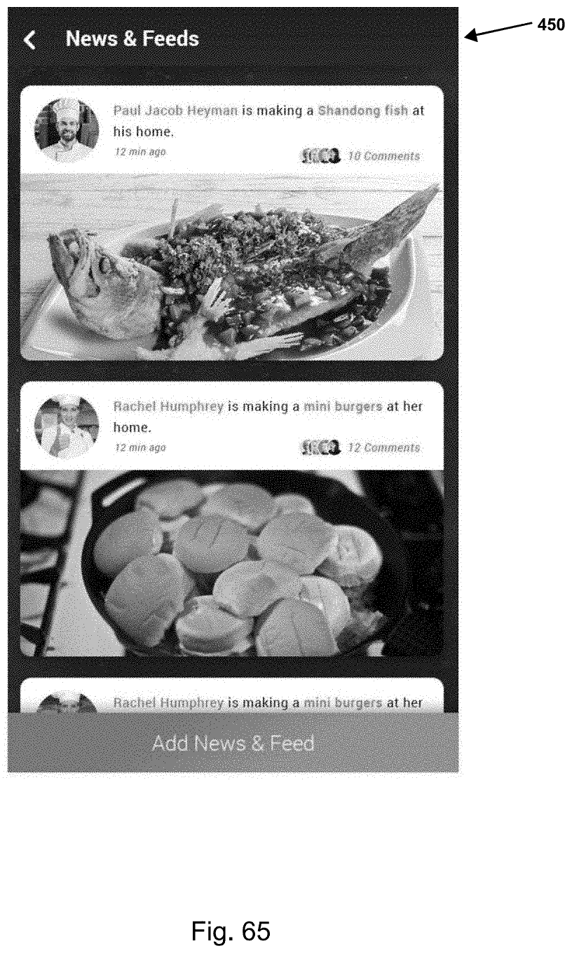

FIG. 66 is a diagram illustrating a user interface for a news & feed page; the view showing an add news & feed page; the view showing, a title, the view showing an address; the view showing a description; the view showing an add picture and/or video feature; the view showing a save feature;

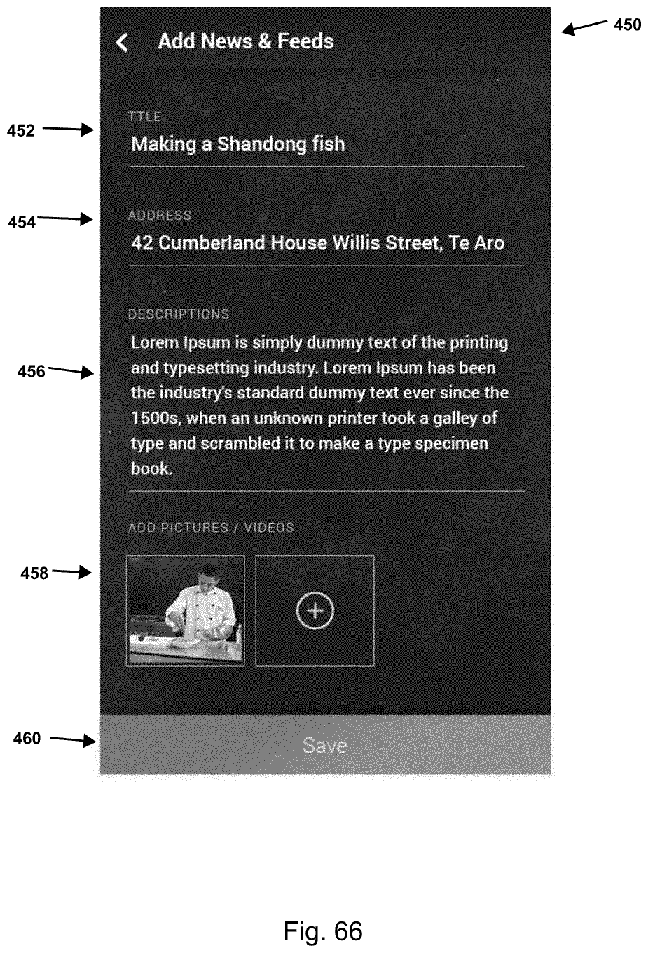

FIG. 67 is a diagram illustrating a user interface for a manage orders page; the view showing a pending orders tab; the view showing a plurality of pending orders;

FIG. 68 is a diagram illustrating a functional concept of the present disclosure;

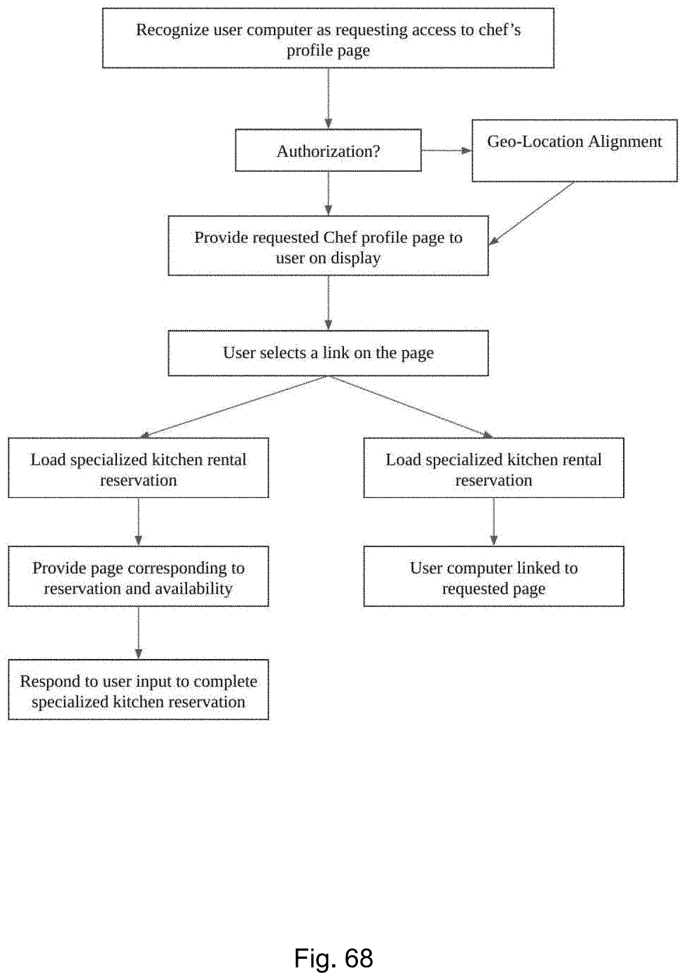

FIG. 69 is a diagram illustrating a functional concept of the present disclosure.

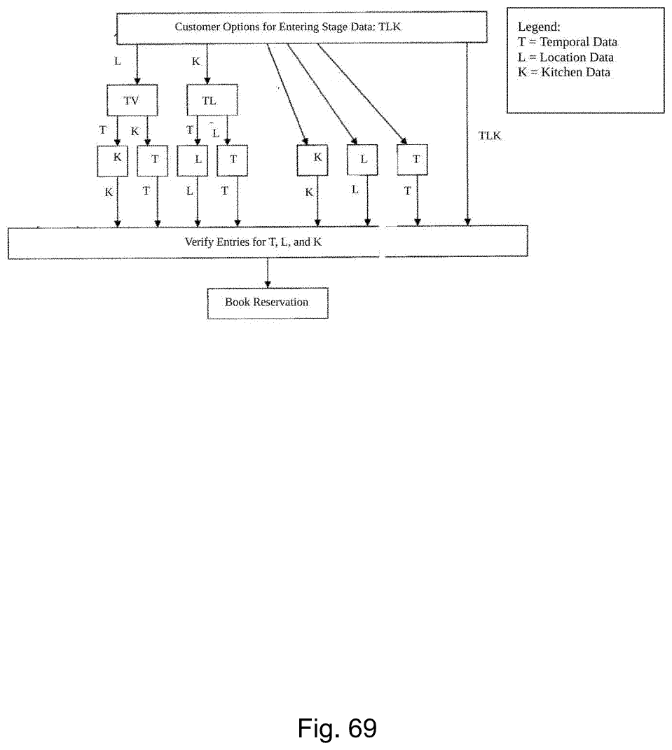

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. in addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“Saas”), Platform as a Service (“PaaS”), and Infrastructure as a Service (“IaaS”)), and deployment models (e.g., private cloud, community cloud, public cloud, and hybrid cloud).

The flowchart and block diagrams in the attached figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

All illustrations of the drawings are for the purpose of describing selected versions of the present invention and are not intended to limit the scope of the present invention.

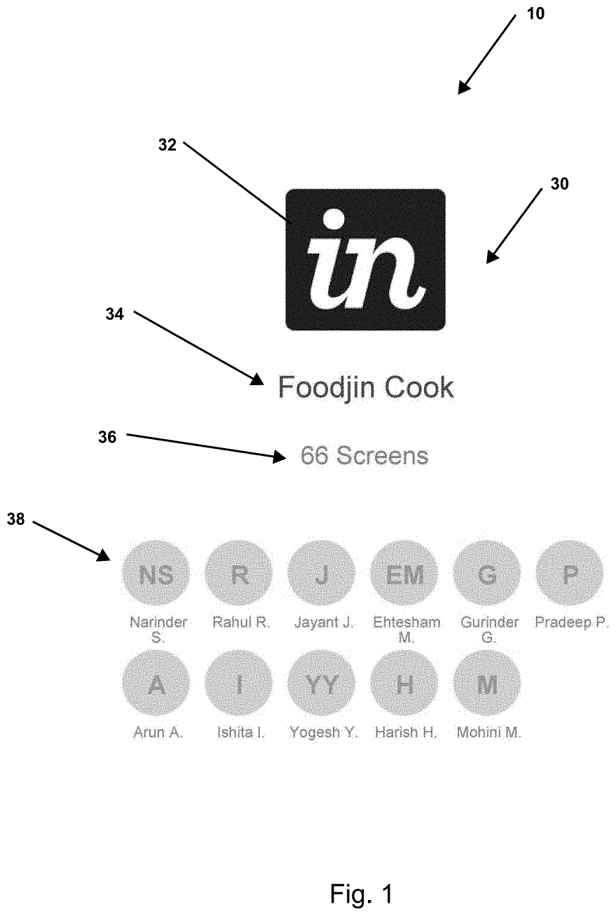

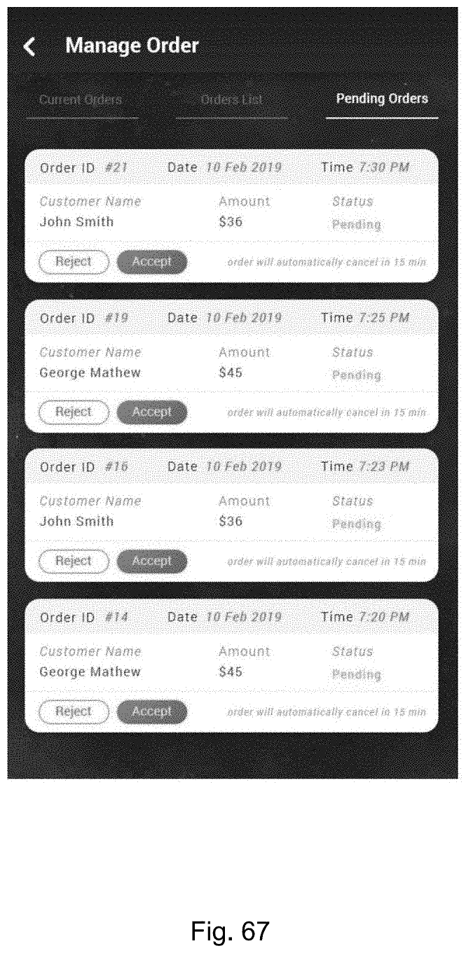

The following descriptions are in reference to FIG. 1 through FIG. 67. The present invention is a food ordering platform designed to offer a new method to order food. Throughout the specification, a “customer” may be a person or any entity who wish to have food ordered and delivered; and a “cook” (also known as a “chef”) may be any person who has the ability to offer food. The cooks can be of any race, ethnicity, gender, etc. The food ordering platform comprises a customer management engine, a cook management engine, a graphical user interface (“GUI”) engine, a search engine, an ordering engine, an order management engine, a communication engine, and a database. Optionally, the present invention further comprises a kitchen engine via which the cook can rent kitchens as needed. It should be noted that the present invention provides a new platform to connect cooks and customers, and it is the cooks who are responsible for food safety. The present invention is preferably in the form of a mobile application which can operate on a mobile device (such as a smartphone, a tablet, etc.) that possesses computing capability and network connectivity. It should be noted that the customers and the cooks may use an integrated app; however, two separate apps, which are specifically designed for the customers and the cooks respectively, may be provided. As used herein, the term “engine” is used to refer to collections of programs which are grouped based upon function.

The customer management engine is used to register customers in the platform and perform authentication of the customers. Customers need to provide their registration information to create an account in the platform. The customer management engine receives each customer's registration information and creates accounts accordingly. For example, the customer's registration information can include but not limited to username, password, location, phone number, payment information, etc. In one embodiment, the payment information is stored in the database for future orders. The registration information can be updated by customers later. In one embodiment, the customer management engine generates login credentials for the customer based on the customer's registration information and stores the login credentials in the database. In this way, each customer is able to access the food ordering platform using the login credentials from their smartphones, laptops, desktops, etc. It should be understood that the present invention may also employ other authentication schemes, including but not limited to graphical password, pattern lock, and biometrics. In one embodiment, customers can register and sign in using their existing social media accounts.

Similar to customer management engine, the cook management engine allows the cook to register in the platform and perform authentication accordingly. For example, the cook's registration information may comprise username, password, social security number, bank account information for receiving payments, phone number, etc. To verify the phone number of a cook, a verification code, which is required to complete the registration process, may be sent to the phone number provided by the cook. Similarly, the verification code can also be sent to an email address to perform verification of the email. The cook management engine further receives, in addition to current and past orders, and stores profile information of the cooks. The profile information can be input by the cooks when creating the accounts. The profile information may comprise location, biograph, menu, etc. Moreover, the cooks can upload exemplary photos or video clips via the cook management engine, as a part of the profile information. In a preferred embodiment, if a cook wishes to join the platform, he/she needs to initiate a request to join. Customers are unable to find the cook and view the profile information until an administrator of the platform approves the joining request. Preferably, to become a registered cook on the platform, the cook must satisfy several requirements. For example, a background check may be conducted upon receiving the joining request. The background check may comprise education or employment history, criminal record, credit history, etc. Moreover, in order to ensure food safety, the cook shall also provide health and safety certifications as well as various kitchen establishment licenses before registering the kitchen from where he/she will cook the food. The cooks can choose to be active to accept orders or inactive to refuse any orders via the cook management engine. However, the cook management engine also allows the administrator to manage the cooks, for example, to mark the cooks as active or inactive when appropriate.

In one embodiment, the cook management engine further allows the cook to create a catalog of offered food. For example, the catalog may comprise categories of the food, the specific food items, and/or special instructions. Further, the cooks are able to choose their own areas of expertise (for example, American food, Mexican food, etc.) and the number of the areas of expertise is limited to for example three to make sure each cook can focus on their own areas. In one embodiment, a cook can specify one or more food items as his/her most unique dishes, which may be exclusive home-made dishes or borrowed dishes from another country. A cook can also edit the catalog, add food items, and edit price, nutritional information (calorie count), pictures, etc. via the cook management engine. In another embodiment, the cook management engine is further configured to allow the cooks to share posts, cooking videos, photos to other cooks and/or customers on the platform.

The GUI engine generates graphical data for displaying a user interface which enables customers and the cooks to interact with the present invention. A customer or a cook can input information into the user interface and the GUI engine relays the information to other engines for further processing. For example, the user interface may include a login box into which customers can enter login credentials, and then the credentials are transmitted from the GUI engine to the customer management engine for customer authentication. If the login credentials do not match with those in the database, the GUI engine will generate a pop-up window requiring the customer to re-enter the credentials. In a preferred embodiment, the GUI engine generates a graphical user interface showing top-rated cooks, top-rated dishes, and top-rated drinks on the home screen.

The search engine enables customers to perform a search to find the desired cooks and/or food. For example, customers can search for cooks based upon location or time availability, keyword (e.g., the name of a cook or a food item), etc. The search engine will instruct the GUI engine to generate a search results interface showing a list of cooks which meet the search criteria set by the customer, such that the customer can select the desired cook. Further, customers are able to filter the results based on the type of food, price, distance, etc. After the selection of the desired cook, the search engine generates an ordering request and send it to the ordering, engine, which will be described in more detail in the following paragraph, for further processing. In one embodiment, the search engine also allows the cooks to quickly locate an order by certain search criteria (for example, date, order number, etc.) or search for a kitchen that is commercially available for rent. In a preferred embodiment, the search engine employs an algorithm which enables the list of cooks (or food items) to be organized based on customer's feedback or ratings.

The ordering engine receives the ordering request and completes the ordering process. Upon receiving the ordering request, the ordering engine instructs the GUI engine to display a list of the food items offered by the selected cook. Customers need to specify ordering information including but not limited to items to be ordered, delivery time, delivery location. In another embodiment, a customer can also pick up their food at the kitchen. In this embodiment, the address of the kitchen is sent to the customer. After collecting the ordering information, the ordering engine produces an order using, the ordering information and send the order to the selected cook. The cook then can review the ordering information included in the order and decide whether or not to accept the order. Once the order is accepted, the ordering engine creates an order entry comprising the ordering information and stores it in the database.

The order management engine allows customers to track their current or previous orders. The customers can check when the order was received and accepted and become aware of an estimated time of delivery. The customers can also review order history via the order management engine. In one embodiment, uncompleted orders may be marked in yellow; completed orders may be in green; and canceled orders may be presented in red. In a preferred embodiment, the order management engine also enables customers to leave feedback about the food they ordered and/or the cook who prepared the food. For example, the customers can leave feedback via a URL link which is sent via text messages or email after the order is delivered.

In one embodiment, the order management engine is further configured to manage orders for the cook. Preferably, a list of chronological order summaries with recent ones on top is provided, so that the cook can readily review multiple orders. In a preferred embodiment, each order summary may comprise information including but not limited to customer name, total amount, order status, etc.

The kitchen engine is optional. If the cooks do not have their own kitchens, kitchen engine allows them to rent a commercial kitchen via the kitchen engine. The kitchen engine generates a list of the commercial kitchens for the cooks to choose from. The commercial kitchen may be provided by a registered third-party and may be rented for a short period of time (for example, two hours) or a whole day. In this way, a cook can work from different kitchens in a day if necessary. In one embodiment, cancellation of the kitchen appointment may result in a cancellation fee which should be paid by the cook canceling the appointment. In a further embodiment, the registered kitchens are available for booking within a predetermined time window (for example on weekends). The appointments are subject to availability and are scheduled on a first come, first served basis.

Although the invention has been explained in relation to its preferred embodiment, it is to be understood that many other possible modifications and variations can be made without departing from the spirit and scope of the invention.

System

With reference to the figures, a food ordering system 10, platform, and method of use is presented (hereafter known as “food system” or simply “system”). Food system 10 is formed of any suitable size, shape and design. In the arrangement shown, as one example, system 10, which may comprise remote servers, databases, application servers, application databases, application programming interfaces, product databases, mobile applications, and/or computers that fulfill the functions disclosed herein, also includes, in the embodiment depicted, a graphical user interface 12, a database 14, a plurality of datasets 16, accounts 18, chefs 20, and users 22 among, other components.

In the arrangement shown, as one example, system 10 comprises remote servers, databases, and/or computers that fulfill the functions disclosed and described herein. In the embodiment depicted, system 10 comprises an application server. Application server comprises one or more computer systems adapted to transmit and receive data regarding selected datasets related to various users and/or datasets related to multiple users. Application server is adapted to query database with unique identification codes to retrieve a list of foods and/or product and/or services related to various chefs. Application server is also adapted to query a food database. Additionally, the application server may communicate with a mobile application, which is adapted to present the product information in a form conducive to being viewed on a mobile device and/or handheld device.

The appearance of the presentation of the product information and/or the process windows for researching hundreds of chefs and/or events may be customized with data of particular relevance to the customer/or the product and/or the event type. As one example, the appearance of windows and/or the process for researching hundreds of chefs may be customized for pricing information, trending information, and/or other information related to food and/or product offerings by venues.

As one of ordinary skill in the art may understand, application server, product database, and other databases mentioned herein may be implemented in one or more servers. Additionally, multiple servers may have mirrored data to prevent data loss in case of disk failure and/or to decrease access and response times for database queries. In alternative embodiments, application server, and other database procedures may be carried out on computer-readable instructions and data stored on the customer's mobile computing device. Additionally, system 10 includes an application programming interface (“API”) which includes tools and resources enabling a user to operate the embodiments herein.

Graphical User Interface:

In the arrangement shown, as one example, system 10 includes a graphical user interface 12. Graphical user interface 12 is formed of any suitable site shape arid design and is configured to present chef and food data to a user in an easy to use manner. Said another way, graphical user interface 12 is configured to allow chefs to set up online kitchens in which they can advertise, market, and supply their services to a market. Additionally, graphical user interface 12 is configured to provide a plurality of users with access to and booking chef services.

Furthermore, graphical user interface 12 provides an easy way for both chef and user to upload information to a database, storing that information, sharing that information, and using that information to provide and or acquire services for food, among other services, as well as food itself. Graphical user interface 12 is an exemplary method by which systems of the present disclosure may represent, provide, connect, book, retrieve, and organize services for food, chef services, catering, and more. Using graphical user interface 12 allows a chef to connect with customers and allows customers and/or user to hire chefs.

In the arrangement shown, as one example, graphical user interface 12 includes a landing page 30, a chef registration page 50, a chef home page 80, a chef profile page 130, a chef's document feature 160, a kitchen page 200, a manage catalogue page 264, a manage orders page 340, an earnings page 410, and news & feed feature 450, among other pages, features, and other components.

Landing Page: In the arrangement shown, as one example, system 10 includes an initial starting page for devices not previously registered in the database. Alternatively, for devices recognized in the database, the chef and/or user will be redirected to a login page as the landing page. The landing page 30, for unregistered and/or unrecognized devices is a sign up and/or create account series of pages which guides a chef and/or new user through a series of screens to guide the chef and/or user in creating an account. In this way, landing page 30 is formed of any suitable size, shape, and design and is configured to generally be the main page a user utilizes to start the website and/or graphical user interface 12. In addition, and in the arrangement shown, the landing page 30 may also serve as a splash, often times being the first page or a page by which a user lands after logging into their account. Additionally, the landing page 30 may provide a plurality of page links and/or tabs for navigating the graphical user interface 12.

Additionally, and said another way, the landing page 30 is configured to help a chef and/or user manage accounts or access various accounts. In other words, the landing page 30 is configured to help a chef and/or user choose an account or switch between different accounts as well as disable or activate various accounts. Additionally, this feature is designed to supply other actions and components, such as deleting accounts and/or launching previously disabled accounts. Additionally, in the landing page 30, a user may select the desired account/product and focus on a particular product or menu item, and complete other features such as disabling a product advertising in the event of sellout or any other event.

In this arrangement, as one example, a chef and/or user accesses their account via a login page as part of the landing page. In this way, the landing page is the entrance page to the graphical user interface 12. In this way, login page serves the purpose of computer security, and is the page through which a sponsor and/or user gains access to system 10 by identifying and authenticating themselves. In the arrangement shown, as one example, login page includes a display, a username, a password, a log in, among other components.

In the arrangement shown, as one example, landing page 30 includes an insignia 32, an identifier 34, a screen statistic 36, user profiles 38, phone number entry 40, and a sign up link 42, among other options, controls, features, and components.

Chef Registration Page: In the arrangement shown, as one example, graphical user interface 12 includes a chef registration page 50 (also known as a “registration page”). Registration page 50 is formed of any suitable size, shape, and design and is configured to guide a chef through a step-by-step process which gathers information about the chef and/or the operations of the chef in order to create a chef and/or kitchen profile for the chef. In the arrangement shown, as one example, a chef must register with the system in order to supply their services. Once a chef is registered and has activated their account, they are able to start offering services for users to find through the system.

Said another way, and in the arrangement shown, as one example, chef registration page 50 is configured to provide a plurality of data entry points, then storing the plurality of data entries into a database. Once this information is stored in a database and associated with an account, the data can be used to retrieve the account for the registration of a chef. This registration information can be associated with other information including a chef's kitchen and can other information and interactions further disclosed herein.

Furthermore, and in the arrangement shown, the chef registration page acts as a filter for checking qualifications and security. in this way, the chef registration page is configured to provide a step-by-step security check. Additionally, the chef registration page 50, in the arrangement shown, requires social security number input for a background check. In this way, a background check can be completed once registration is complete because the chef registration page 50 gathers the information needed to complete a background check. In this way, the registration page 50 provides a step-by-step function for registering an account, creating an account, and filtering out those who do not qualify for creating accounts.

In the arrangement shown, as one example, chef registration page 50 includes a phone number feature 51, a phone number entry feature 52, a continue component 54, a username feature 55, a username entry feature 56, an email entry feature 58, a name feature 60, an address feature 62, a country feature 64, a city feature 66, a zip code feature 68, a social security number feature 70, a background check function 71, a registration verification component 72, and a user profile preview page 76, among other options, controls, features, and components.

Chef Home Page: In the arrangement shown, as one example, graphical user interface 12 includes a chef home page 80 (also known as a “home page”). In the arrangement shown, as one example, system 10 also includes a home page 80. Home page 80 is formed of any suitable size, shape, and design and is configured to generally be the main page a user utilizes to navigate the website and/or graphical user interface 12. In addition, and in the arrangement shown, the home page 80 may also serve as a landing, page, often times being the first page or a page by which a chef lands after logging into their account. Additionally, the home page 80 provides a plurality of page links and/or tabs 81.

Tabs 81 are formed of any suitable size, shape, and design and are configured to give the user a way to navigate the graphical user interface 12. In the arrangement shown, as one example, tabs 81 are arranged along the top of each various page and are designed to provide visual queues not only to what page the user is on but also to indicate to a user what tab page they are viewing but provide context clues as to what each tab 81 provides from a functionality perspective. The plurality of tabs 81 includes a News & Feeds Tab 90 and a Daily Orders Tab 96, among other tabs. In the arrangement shown, as one example, the tabs 81 disclosed herein provide links to the associated pages. However, any other number of tabs or arrangement of tabs is hereby contemplated for use.

In the arrangement shown, as one example, chef home page 80 also includes various links and indicators that identify various statistics and/or information relevant to a chef. Additionally, the various links provide a means of accessing the various functionalities of system 10 to help a chef achieve goals and or manage operations. Among other features, linkes, options, controls, and components, chef home page 80 includes an options link 82, a page indicator feature 84, a status indicator 86, a profile identifier 88, a complete profile link 90, a news link 91, a feed link 92 and/or a news and feed link 92, a news and feed screen 94, a daily orders feature 96, a daily orders screen 98, an available indicator 102, a latest orders feature 112, and an orders page 113.

In the arrangement shown, as one example, chef home page 80 includes an orders page 113. Orders page 113 is formed of any suitable size, shape, and design and is configured to provide a page for identifying, viewing, modifying, and arranging orders 114. Orders page 113 displays a plurality of orders 114. Orders are a dataset which conveys information to the chef related to an order placed. The chef is able to modify and manipulate a variety of information related to an order 114.

Orders 114 may include, but are not limited to various information and features, including but not limited to, an order ID 115, a date 116, a time 117, a customer. ID 118, an amount 119, a status 120, among other options, controls, features, and components.

Chef Profile Page: In the arrangement shown, as one example, graphical user interface 12 includes a chef profile page 130 (also known as a “profile page”). Chef profile page 130 is formed of any suitable size, shape, and design and is configured to provide and display various information from a dataset about a chef and or chef offerings. Additionally, in the arrangement shown, chef profile page 130 provides a chef guidance in changing details about the chef and/or the offerings. Additionally, in the arrangement shown, chef profile page 130 displays other information about the chef such as reviews left by previous clients, what the chef is rated highly at, what type of food the chef serves, and more.

In the arrangement shown, as one example, chef profile page 130 includes a name feature 132, an email feature 134, an address feature 136, a plurality of identifiers 138, an edit tool 140, a rating component 142, a review count 144, a password change feature 146, a compliments component 148, a taste component 150, a hygiene component 152, a presentation component 154, a staff component 156, a reviews feature 158, and an edit profile page 159 and associated features, among other options, controls, features, and components.

Chef's Document Feature: In the arrangement shown, as one example, graphical user interface 12 includes a chef's document feature 160 (also known as a “document page” or “chef's document page”). Chef's document page 160 is formed of any suitable size, shape, and design and is configured to allow a chef to upload various needed documents to a database. Various documents may be needed to prove identity of the chef as well as prove various licenses a chef may have or not have, such as a food serving license, a business license, a proof of id, a proof of insurance, and more. In the arrangement shown, as one example, the chef's document page 160 allows a chef to remove, modify, update, and add various documents associated with the chef and/or the chef's business.

In the arrangement shown, as one example, document page 160 includes credentials 162, identification 164, a plurality of licenses 166, a plurality of other documents 176, an employment identification number 168, a food license 170, a plurality of proof of insurance 172, a plurality of other licenses 174, and an upload documents, feature 178, among other options, controls, features, and components.

Payment Page: In the arrangement shown, as one example, graphical user interface 12 includes a payment page 180 (also known as an “balance page”). Balance page 180 is formed of any suitable size, shape, and design and is configured to track and display a balance owed to the chef, how much money a chef has accrued, provide the ability to add a payout method, pay the chef, provide the chef a way to update payout method data, and more.

In the arrangement shown, as one example, balance page 180 includes an add payout method feature 182, a remove payout method feature 184, an update payout method component 186, an add payment method 187, a remove payment method 188, an add payout method page 190, and an add payout method credentials 192, among other options, controls, features, and components.

Kitchen Page: In the arrangement shown, as one example, graphical user interface 12 includes a kitchen page 200 (also known as a “kitchen home page” or “operations page”). Operations page 200 is formed of any suitable size, shape, and design and is configured to be the main interaction page between chef and system 10. In the arrangement shown, as one example, kitchen home page 200 displays various information stored in a database to the chef in an easy to read and understand way such that. the chef can quickly determine any actions the chef needs to take. In addition, and in the arrangement shown, the kitchen page 200 provides a chef information related to products and/or services the chef is currently offering for sale to a plurality of users. The kitchen page 200 provides a means for a chef to easily get an overview on the entire business a chef is running through system 10.

In the arrangement shown, as one example, the kitchen home page 200 also displays to a user various information about the chef and/or business and the various product and/or service offerings a user can purchase from a chef. Additionally, and in the arrangement shown, a user can view opinions from reviews provided about the particular kitchen being viewed. The user can make educated decisions based on the information provided about which chef and/or product offering the user may want to purchase. In other words, the kitchen page 200 displays a variety of data in a way easy to digest for both chef and/or user.

In the arrangement shown, as one example, kitchen home page 200 includes a your own kitchen tab 202, a rent kitchen tab 204, an upcoming booking tab 206, a kitchen list 208, an add kitchen feature 210, an add kitchen page 212, an address component 214, a city component 216, a zip code component 218, an add images feature 220, a permit display component 222, an occupancy feature 224, a contract feature 226, a view other documents feature 228, a kitchen selection function 230, an edit kitchen feature 232, a delete kitchen feature 234, a rent kitchen feature 236, a plurality of kitchen tiles 238, a name identifier 240, an address identifier 242, a price identifier 244, a kitchen rent details component 246, a description component 248, a check availability feature 250, a send request feature 252, a make payment feature 254, an upcoming booking page 256, an upcoming booking list 258, a plurality of identifiers 260 of the upcoming booking list 258, a cancel booking feature 262, among other options, controls, features, and components.

Manage Catalogue Page: In the arrangement shown, as one example, graphical user interface 12 includes a manage catalogue page 264 (also known as a “catalogue page”). Catalogue page 264 is formed of any suitable size, shape, and design and is configured to store and retrieve data associated with the various product offerings a chef may have. Said another way, and in the arrangement shown, the manage catalogue page 264 provides a method for a chef to add, remove, edit, and update offerings.

Said another way, this page allows a chef to view all current products the chef is offering, update those products, remove products, and more. For example, a chef may manage their current menu through the manage catalog page 264. Additionally, a chef may remove items if the items have sold out or an item has run out of stock during operations.

In the arrangement shown, as one example, manage catalogue feature 264 includes a settings feature 266, a categories tab 268, a food item tab 270, an attributes tab 272, a plurality of categories 274, an edit category feature 276, a delete category feature 278, an add category feature 280, a category name feature 282, a display order feature 284, a plurality of food items 286, an add food item feature page 288, an edit food item feature page 290, a remove food item feature 292, a food item filter search feature 294, a product name identifier 296, a category identifier 298, a published feature 300, an add item feature 302, an item name feature 304, an item category feature 306, an item cuisine feature 308, an item price identifier 310, an item type identifier 312, a preference feature 314, a published component 316, an item preparation time identifier 318, an item availability feature 320, a plurality of item nutrition identifiers 322, a plurality of dish pictures 324, an add attributes feature 326, an attributes page 328, a plurality of attributes 330, an add attribute feature 332, an edit attribute feature 334, and a remove attribute feature 336, among other options, controls, features, and components.

Manage Orders Page: In the arrangement shown, as one example, graphical user interface 12 includes a manage orders page 340 (also known as a “orders page”). Orders page 340 is formed of any suitable size, shape, and design and is configured to organize and manage past, present, and potentially future orders for a chef and/or user. In other words, order page 340 automatically organizes, as well as allows for manual organization. Said another way orders page 340 represents and automatically updates data related to orders for a chef and/or orders placed by a user.

In the arrangement shown, as one example, orders page 340 includes a current orders tab 342, an orders list tab 344, a pending orders tab 346, a search orders feature 348, a plurality of order tiles 350, a plurality of order tile identifiers 352 of the order tiles 350, an update order status feature 354, an orders list tab 356, a show current orders feature 358, a day of the week feature 360, a search orders feature 366, an order identification search component 368, an order date search component 370, an order status search component 372, an order details page 374, an order identification component 376, an order status component 378, an order time component 380, an order amount component 382, an order status visual indicator feature 384, an order summary 386, an item count feature 388, a new order notification feature 390, a new order details feature 392, a reject feature 394, an accept feature 396, an order status update feature 398, a notifications page 400, a new notification count feature 402, a plurality of notifications 404, among other options, controls, features, and components.

Earnings Page: In the arrangement shown, as one example, graphical user interface 12 includes an earnings page 410 (also known as a “financial page”). Financial page 410 is formed of any suitable size, shape, and design and is configured to automatically calculate, display, and update financial information associated with a chef and/or user account.

In the arrangement shown, as one example, this information includes, but is not limited to, earnings by the chef, payments, balances and other financial information for both chef and user. Additionally, and in the arrangement shown, this information is automatically broken down into a variety of data and displayed in an easy to read fashion to the chef and/or user. In the arrangement shown, such information is displayed in relation to earnings, total earnings, weekly earnings, daily earnings, amount dues, and more.

In the arrangement shown, as one example, earnings page 410 includes an in progress tab 412, an in review tab 414, an in process tab 416, a total earnings tab 418, an earnings in progress tab 420, an earnings in progress count feature 422, a plurality of orders in progress feature 424, an earnings under review feature 426, a plurality of orders under review feature 428, a total earnings in process feature 430, a plurality of orders in process 432, a total earnings feature 434, a total earnings count feature 436, a plurality of total orders feature 438, a week list feature 440, a bi-weekly list feature 442, a monthly indicator 444, a previous week feature 446, and a next week feature 448, among other options, controls, features, and components.

News & Feed Feature: In the arrangement shown, as one example, graphical user interface 12 includes a news & feed feature 450 (also known as a “news page” or “feed page” or “news & feed page”). News & feed page 450 is formed of any suitable size, shape, and design and is configured to provide a news & feed for the chef and/or the user. In this way, and as is shown in one arrangement, the news and feed can be viewed and added to by the chef and/or user. In this way, and as one example, a chef may be able to add news to the feed about a new dish which they are releasing.

Additionally, and in the arrangement shown, a user may be able to post to the news and feed information about an event they are hosting and the type of chef they need and or event help they need. Said another way, the news & feed page 450 provides a means for communication, displaying data, and adding data to the server by chef and/or user and/or other contributors such as the creator of system 10 and/or other users of system 10.

In the arrangement shown, as one example, news & feed feature page 450 includes title identifier 452, an address feature 454, a description component 456, a videos and/or photos feature 458, a save feature 460, and a post feature 462, among other options, controls, features, and components.

In Operation/Method of Use:

As one example, a food ordering system, platform, and method of use for creating a chef profile page, creating a user account, creating a specialized kitchen, and booking reservations with the kitchen from the standpoint of the user is presented herein. The system 10 presents multiple ways of accomplishing this task and others, including accounting for financials and more.

Additionally, and in an alternative embodiment, a chef or a plurality of chefs may book a kitchen directly from a supplier. The supplier or owner of the system having a plurality of rental kitchens available for chefs to book directly with the supplier. In this arrangement, and said another way, a chef or plurality of chefs could book any number of rental kitchens offered by a supplier for various uses, including bringing in a plurality of users to the kitchen, events, and the like.

It will be appreciated by those skilled in the art that other various modifications could be made to the device without parting from the spirit and scope of this disclosure. All such modifications and changes fall within the scope of the claims and are intended to be covered thereby.

What is claimed:

1. A system for administering a kitchen rental reservation booking, the system comprising:
a computer system;
the computer system comprising a database, the computer system configured to maintain a chef profile in the database;
the computer system configured to maintain a user profile in the database;
the computer system configured to define a plurality of specialized kitchen rental reservation profiles;
wherein each specialized kitchen rental reservation profile comprises at least one division of cuisine and at least one characteristic of a specialized kitchen rental reservation profile;
wherein each specialized kitchen rental reservation profile accepts a chef input, in the form of a plurality of characteristics, toward creating the specialized kitchen rental profile;
wherein the computer system is configured to store data corresponding to the defined specialized kitchen rental reservation profile;
wherein the computer system is configured to store data corresponding to a user profile;
wherein the user profile accesses a graphical user interface to request a booking with the defined specialized kitchen rental reservation profile.

2. The system of claim 1, further comprising: wherein the kitchen rental reservation profile is at least one person who prepares food.

3. The system of claim 1, further comprising: a defined location for the kitchen rental reservation profile.

4. The system of claim 1, further comprising: a plurality of eligible kitchen types for the specialized kitchen rental reservation profile in response to a user input through the graphical interface.

5. The system of claim 1, further comprising: wherein the computer system is configured to define a document page, wherein the document page displays a plurality of documents associated with the specialized kitchen rental reservation profile.

6. The system of claim 1, further comprising: a plurality of sections, wherein the computer system is further configured to define a plurality of characteristics that are to be displayed in the graphical user interface in response to a user input.

7. The system of claim 1, further comprising: a name of the customer associated with the user profile.

8. The system of claim 1, further comprising: a plurality of identifiers associated with the specialized kitchen rental reservation profile.

9. The system of claim 1, further comprising: an availability check for the specialized kitchen rental reservation profile in response to a user input through the graphical interface.

10. The system of claim 1, further comprising: wherein the graphical user interface further comprises a home page, a chef registration page, a chef home page, a chef profile page, a chef's document page, an accounts page, a kitchen page, a manage catalogue page, a manage orders page, an earnings page, and a news & feed page.

11. A method for administering a specialized kitchen rental reservation hooking, the steps comprising:
maintaining a specialized kitchen profile in a database, the specialized kitchen profile being associated with an entity, the entity having a plurality of characteristics;
defining a plurality of specialized kitchen profiles, each specialized in kitchen rental reservations corresponding to a cuisine type and comprising at least one characteristic of a kitchen rental reservation;
defining a plurality of pages of a graphical user interface, each corresponding to a feature and being able to accept an entity input toward creating a specialized kitchen profile.

12. The method of claim 11, further comprising the steps:
maintaining a user profile in a database, the user profile being associated with a customer, the customer having a plurality of characteristics;
wherein the customer performs the steps of booking a specialized kitchen rental under the control of a graphical user interface.

13. The method of claim 11, further comprising the steps:
storing data corresponding to the specialized kitchen rental profile.

14. The method of claim 13, further comprising the steps:
searching a database by a customer, subsequently retrieving a plurality of specialized kitchen rental profiles.

15. The method of claim 13, further comprising the steps:
checking availability of the specialized kitchen rental profile.

16. The method of claim 13, further comprising the steps:
booking services of the specialized kitchen profile.

17. The method of claim 11, further comprising the steps:
generating a uniform resource locator; wherein a customer can complete booking a reservation with the specialized kitchen reservation profile.

18. The method of claim 11, further comprising the steps:
defining a location for a specialized kitchen reservation profile.

19. The method of claim 11, further comprising the steps:
defining a plurality of eligible specialized kitchen reservation profiles; wherein a plurality of eligible kitchen reservation profiles fit within a scope of defined search criteria.

20. The method of claim 11, further comprising the steps:
defining a product; wherein the product is produced by the specialized kitchen profile.
